(19) United States
(12) Patent Application Publication
(10) Pub. No.: US 2022/0003542 A1
(43) Pub. Date: Jan. 6, 2022

(54) SENSOR APPARATUS

(71) Applicant: Q-BOT LIMITED

(72) Inventors: Ashley Napier, Wandsworth (GB); Shubham Wagh, Wandsworth (GB); Josh Kiff, Wandsworth (GB); Laura Moreira, Wandsworth (GB); Chris Hamblin, Wandsworth (GB); Mathew Holloway, Wandsworth (GB)

(73) Assignee: Q-BOT LIMITED, Wandsworth (GB)

(21) Appl. No.: 17/285,044

(22) PCT Filed: Sep. 23, 2019
(86) PCT No.: PCT/GB2019/052665

§ 371 Date: Apr. 13, 2021

(30) Foreign Application Priority Data
Oct. 15, 2018 (GB) 1816770.0
Sep. 23, 2019 (GB) 1913684.5

(51) Int. Cl. G01C 3/02; G01C 11/02; G01C 15/00; G01S 17/86; G01S 17/89; G01S 7/481

(52) U.S. Cl. CPC G01C 3/02; G01C 11/025; G01S 7/4817; G01S 17/86; G01S 17/89; G01C 15/002

(57) ABSTRACT

There is provided a portable sensor apparatus (10) for surveying within a room (30) of a building. The sensor apparatus (10) comprises: a sensor unit (12) for temporary insertion into a room (30), the sensor unit (12) being moveable in a scanning motion, and comprising a plurality of outwardly directed sensors (16, 20, 24) arranged to capture sensor data associated with an environment of the sensor apparatus (10) as the sensor unit is moved through the scanning motion. The plurality of sensors (16, 20, 24) comprises: a rangefinder sensor (16); a thermal imaging sensor (20); and a camera (24).

This invention relates to sensor apparatus and a method of operating the same.

### BACKGROUND

Monitoring the condition of buildings, such as domestic houses, shops or offices, typically requires manual recording of the status of various features of the building. When there is a requirement for remedial, maintenance or improvement work to be performed at the building, typically a tradesman will visit the premises in order to provide a quote for the work, which can be approved by the budget-holder. It is difficult to obtain an accurate quote for work to be performed at the building without a site visit by the tradesman to accurately assess the situation.

There have been efforts made to capture some visual data in relation to buildings, for example low fidelity detail of the external appearance of the building can be obtained through Google Maps® or the internal appearance can be captured using systems provided by companies such as Matterport. However, the information available is not sufficient to enable an accurate and detailed understanding of the condition of the building, monitoring of its status or to facilitate decision making.

It is in this context that the present invention has been devised.

### BRIEF SUMMARY OF THE DISCLOSURE

In accordance with the present disclosure there is provided a portable sensor apparatus for surveying a building. The sensor apparatus comprises a rotatable sensor unit for temporarily locating at the building. The rotatable sensor unit is configured to rotate about an axis of rotation. The rotatable sensor unit comprises a plurality of outwardly directed sensors mounted for rotation with the rotatable sensor unit and to capture sensor data associated with an environment of the sensor apparatus. The plurality of sensors comprises: a rangefinder sensor; one or more thermal imaging sensors; and one or more cameras.

In accordance with another aspect of the present disclosure, there is provided a portable sensor apparatus for surveying a building. The sensor apparatus comprises a sensor unit for temporarily locating at the building, the sensor unit being moveable in a scanning motion and comprising a plurality of outwardly directed sensors arranged to capture sensor data associated with an environment of the sensor apparatus as the sensor unit is moved though the scanning motion. The plurality of sensors comprises: a rangefinder sensor; a thermal imaging sensor; and a camera.

In accordance with a further aspect of the present disclosure, there is provided a portable sensor apparatus for surveying a building. The sensor apparatus comprises a sensor unit for temporarily locating at the building. The sensor unit is moveable in a scanning motion and comprises a rangefinder sensor and a plurality of outwardly directed thermal imaging sensors arranged to capture sensor data associated with an environment of the sensor apparatus as the sensor unit is moved through the scanning motion. Each of the rangefinder sensor and the plurality of thermal imaging sensors has a field of view, and the field of view of each of the plurality of thermal imaging sensors at least partially overlaps the field of view of the rangefinder sensor. In addition, the field of view of each of the plurality of thermal imaging sensors at least partially overlaps the field of view of at least one of the other thermal imaging sensors of the plurality of thermal imaging sensors.

In preferred examples, a combined field of view of the plurality of thermal imaging sensors matches the field of view of the rangefinder sensor.

Thus, the portable sensor apparatus allows a single sensor unit to be used to capture visual, thermal and depth information representative of the building in a simple, convenient manner. As will be explained further hereinafter, the sensor data can be fused together relatively easily compared to if the sensor data had been collected from a plurality of separate sensor devices. By capturing visual information, thermal information and depth information for a building, it is possible to acquire a detailed record of one or more aspects of the state of the building to support monitoring and quality assurance tasks relating to the building. The portable sensor unit can be moved into and out of one or more regions, for example rooms, of the building for creating a complete data set of the one or more regions of the building.

The portable sensor apparatus may be for surveying within the building, for example within one or more rooms of the building. In examples, the portable sensor apparatus may be for surveying an exterior of the building.

In some examples, the sensor unit is configured to rotate about an axis of rotation. In examples, the sensor unit is arranged to rotate through the scanning motion. The plurality of sensors are mounted for rotation with the sensor unit.

The axis of rotation may be substantially vertical. The axis of rotation may be, for example, substantially horizontal. In examples, the axis of rotation may be configured to be moveable between two or more directions. In some examples, the sensor unit may be rotatable about two or more axes, for example a substantially vertical axis and a substantially horizontal axis.

It is intended that for some rooms a complete set of sensor data associated with the room can be captured by the sensor apparatus being located in a single location in the room and being rotated to capture data. It will be understood that in other rooms, it may be necessary to reposition the sensor unit of the sensor apparatus one or more times. For a typical domestic room 2-4 scans are enough to capture a substantially complete data set. To locate one room to another the sensor unit of the sensor apparatus may be positioned near a doorway or other aperture in the room to capture information from two rooms simultaneously. This ensures that data registration and alignment for sensor data associated with adjacent spaces, for example adjacent rooms, is simplified.

The environment of the sensor apparatus includes surroundings of the sensor apparatus, for example including a position, appearance and temperature of any features of the building, for example in the room or defining a boundary of the room, as well as features observable by the plurality of sensors and located outside the building and/or outside the room.

It will be understood that the plurality of sensors being mounted for rotation with the sensor unit means that on rotation of the sensor unit through the scanning motion, each of the plurality of sensors, being the rangefinder sensor, the thermal imaging sensor and the camera, will rotate together with the sensor unit. Although it is possible that some of the plurality of sensors may be capable of rotating relative to other sensors of the sensor unit, those sensors, absent any individual movement, will still rotate with the sensor unit.

The rangefinder sensor may be a laser rangefinder. Preferably, the rangefinder sensor is a LiDAR sensor. In some examples, the rangefinder sensor is a steady state LiDAR sensor. The rangefinder sensor may be provided by a plurality of cameras, which may be the camera of the sensor unit. Specifically, the rangefinder sensor may be provided by two stereoscopic cameras. The rangefinder sensor may be an infrared rangefinder sensor. The rangefinder sensor may be provided by a structured light depth camera. It will be understood that any other sensor or collection of sensors may be mounted for rotation with the sensor unit to detect the depth information associated with the building, for example the room.

The camera may be a colour camera, for example an RGB camera. As described hereinbefore, the camera may be used to capture depth information and therefore function as the rangefinder sensor.

The thermal imaging sensor is typically configured to output a thermal image indicative of a thermal reading associated with a plurality of different positions in the environment of the sensor apparatus. The thermal imaging sensor may have a resolution of at least 100×100 pixels, for example at least 160×120 pixels. Thus, it is possible to obtain a relatively localised indication of the thermal information associated with different regions in the room of the building. Typically, the resolution of the thermal imaging sensor is of a lower fidelity than the resolution of the rangefinder sensor and the one or more cameras. By comparing information from higher resolution sensors including the one or more cameras and the rangefinder sensor the fidelity of the thermal image can be increased.

The sensor unit may be considered, for example, a sensor turret.

The portable sensor apparatus may further comprise a support structure to which the sensor unit is mountable. The sensor unit may be mounted for rotation relative to the support structure. In preferred examples, the sensor unit is mounted for motorised rotation relative to the support structure. The portable sensor apparatus may comprise a motor for motorised rotation of the sensor unit. Rotation of the sensor unit thereby provides the scanning motion, allowing the plurality of sensors to capture sensor data associated with an environment of the sensor apparatus. Thus, a motor can be used to rotate the sensor unit while a user, such as an operator or handler, attends to other surveying tasks for surveying the building. The sensor unit may be mounted for motorised rotation at a substantially constant rate of rotation. Alternatively, or additionally, the sensor unit may be mounted for motorised rotation at a variable rate whereby to achieve a desired spatial resolution of the sensor data. In other words, for a given spatial resolution across a surface, it will be understood that a lower rate of rotation is required when the surface is further from the sensor apparatus fora fixed spatial resolution of, for example a laser rangefinder sensor in a circumferential direction.

Preferably, the sensor apparatus includes a controller configured to control the sensor unit to rotate through the scanning motion such that the plurality of sensors capture the sensor data associated with 360 degrees of the environment of the sensor apparatus. In other examples, the controller may be configured to rotate the sensor unit through less than 360 degrees, for example 90 degrees, 120 degrees, or 180 degrees, depending on the building or part of the building being scanned.

The thermal imaging sensor and the camera are each arranged such that a principal axis of each of the thermal imaging sensor and the camera intersects with the axis of rotation of the sensor unit. Thus, as the sensor unit rotates, each of the plurality of sensors will observe the room from substantially the same radial line defined radially outwards from the axis of rotation, when projected onto a plane transverse to the axis of rotation, albeit that some of the plurality of sensors may observe the room from the same radial line at a different point in the rotation of the sensor unit, such as a different point in time. This ensures that there are substantially no objects in the scene observed by only a portion of the plurality of sensors that are occluded by obstacles due to an edge of the obstacle having a direction substantially parallel to the axis of rotation. It will be understood that if an object is observed by one sensor of the plurality of sensors, the sensors being arranged in this way ensures that, if the object is within the field of view of another of the plurality of sensors at a given rotational position, the object will not be obscured by an edge of any other object in the scene, the edge being in a direction substantially parallel to the axis of rotation. This reduces errors, for example by minimising dead spots, when fusing data captured from different sensors of the plurality of sensors. It will be understood that the arrangement described above does not preclude a portion of the sensors from observing an object in the scene which can be occluded by an edge of an obstacle in the scene for other sensors, the edge being in any other direction than the axis of rotation, particularly in directions transverse to the axis of rotation.

In one example, the plurality of sensors are arranged such that an optical centre of each of the plurality of sensors is spaced from a sensor unit plane transverse to the axis of rotation by a distance of less than five centimetres. Thus, the compact arrangement ensures a reduced number of objects occluded in some of the plurality of sensors by edges in the direction of the sensor unit plane.

It will be appreciated that where the principal axes of any two of the plurality of sensors both share the same angle relative to the axis of rotation, this ensures that if an object is observed by one of the two sensors, and the object is within the field of view of the other of the two sensors at a different rotational position, it can be assumed that the object will not be obscured by any other object in the scene, assuming the objects in the scene have not moved.

The term principal axis as used herein is intended to refer to a line through an optical centre of a lens such that the line also passes through the two centres of curvature of the surface of the lens of a sensor or through the sensor itself where there is no lens. The path of a ray of light travelling into the sensor along the principal axis (sometimes referred to as the optical axis) will be unchanged by the lens. Typically, the principal axis is an axis defining substantially the centre of the field of view of a sensor. In this way, it can be seen that each of the plurality of sensors, including the rangefinder sensor, the camera and the thermal imaging sensor define a principal axis. In examples where a sensor comprises more than one sensor unit, for example the camera may comprise a plurality of cameras, or the thermal imaging sensor may comprise a plurality of thermal imaging sensors, then the principle axis of the sensor is the central axis of the combination of the sensors, which may or more may not be aligned with the principle axis of a particular sensor.

A field of view of the rangefinder sensor may be at least 180 degrees. The field of view of the rangefinder sensor may be such that the rangefinder sensor is configured to detect an object spaced by a rangefinder minimum distance from the sensor unit in either direction along the axis of rotation. In other words, the field of view of the rangefinder sensor may therefore be greater than 180 degrees. The field of view of the rangefinder sensor may be aligned with the axis of rotation. In other words, where the axis of rotation is vertical, then the field of view of the rangefinder sensor may be aligned substantially vertically, that is the field of view of the rangefinder sensor may be at least 180 degrees about an axis substantially transverse to the axis of rotation.

A field of view of the camera may be at least 180 degrees. A field of view of the one or more cameras together may be such that the one or more cameras are configured together to detect an object spaced by a camera minimum distance from the sensor unit in either direction along the axis of rotation. In other words, the field of view of the one or more cameras may therefore be greater than 180 degrees about an axis substantially transverse to the axis of rotation.

A field of view of the thermal imaging sensor may be at least 180 degrees. In examples where the thermal imaging sensor comprises a plurality of thermal imaging sensors, a field of view of the thermal imaging sensors together may be such that the one or more thermal imaging sensors are configured together to detect an object spaced by a thermal imaging sensor minimum distance from the sensor unit in either direction along the axis of rotation. In other words, the field of view of the thermal imaging sensor may therefore be greater than 180 degrees about an axis substantially transverse to the axis of rotation.

Thus, providing the objects in the environment of the sensor apparatus, for example within the room, and the boundaries of the environment of the sensor apparatus, for example the boundaries of the building and/or the boundaries of the room, are sufficiently spaced from the sensor apparatus, dead spots in the detection field of view of the sensors of the sensor unit can be minimised or even completely eliminated, unless an object is obscured by another object in the environment.

The camera may comprise a plurality of cameras, wherein a camera field of view of each of the plurality of cameras when the sensor unit is in a first rotational position partially overlaps the camera field of view of at least one other of the plurality of cameras when the sensor unit is in either the same or a further rotational position of the sensor unit. Thus, the field of view of the plurality of cameras together can be expanded beyond the field of view of any one of the plurality of cameras. The overlap may be less than 10 percent. A partial overlap in the sensor data allows for simplified data combination of the sensor data from each of the one or more cameras. In particular, overlap in the sensor data allows for cross-calibration between sensors of the same type, for example, consistency of colour normalisation, white balance and exposure control.

The thermal imaging sensor may comprise a plurality of thermal imaging sensors, wherein a thermal imaging sensor field of view of each of the plurality of thermal imaging sensors when the sensor unit is in a first rotational position partially overlaps the thermal imaging sensor field of view of at least one other of the plurality of thermal imaging sensors when the sensor unit is in either the same or a further rotational position of the sensor unit. Thus, the combined field of view of the plurality of thermal imaging sensors can be expanded beyond the field of view of any one of the plurality of thermal imaging sensors. The overlap may be less than 10 percent. A partial overlap in the sensor data allows for simplified data combination of the sensor data from each of the plurality of thermal imaging sensors.

The rangefinder and the one or more cameras may be arranged such that a field of view of the rangefinder is configured to overlap partially with a field of view of the one or more cameras. Thus, initial relative calibration of the one or more cameras with the rangefinder sensor is simplified because both of the rangefinder and the one or more cameras can observe the same object, for example a calibration target in a known position relative to the sensor apparatus, without requiring any movement of the sensor unit. As will be understood any movement of the sensor unit required during calibration can introduce errors into the calibration. Thus, the relative calibration of the one or more cameras with the rangefinder sensor is simpler, quicker and less prone to errors.

The one or more cameras may comprise a first camera having a first camera principal axis and a second camera having a second camera principal axis. The first camera and the second camera may each be arranged such that the first camera principal axis and the second camera principal axis substantially intersect with a first circle in a plane transverse to the axis of rotation and centred on the axis of rotation. As will be appreciated, the first circle is a virtual circle and need not exist on the sensor apparatus itself. Thus, the one or more cameras are arranged to substantially simulate using a single camera with a wide-angle lens. However, the cost and complexity of a single camera of sufficiently high resolution and a wide-angle lens of sufficiently high quality is larger than the cost of two cameras of lower resolution with a lower cost lens. The first camera principal axis may intersect with the second camera principal axis. A radius of the first circle may be non-zero, which helps improve the compactness of the sensor unit.

The sensor unit may comprise a plurality of thermal imaging sensors each having a thermal imaging sensor principal axis. Each of the thermal imaging sensors may be arranged such that the principal axes of the thermal imaging sensors intersect with a second circle in a plane transverse to the axis of rotation and centred on the axis of rotation of the sensor unit. As will be appreciated, the second circle is a virtual circle and need not exist on the sensor apparatus itself. Thus, the thermal imaging sensors are arranged to substantially simulate using a single camera with a wide-angle lens. However, the cost and complexity of a single thermal imaging sensor of sufficiently high resolution and a wide-angle lens of sufficiently high quality is larger than the cost of two or more thermal imaging sensors of lower resolution with a lower cost lens. The principal axis of a first thermal imaging sensor may intersect with the principle axis of a second thermal imaging sensor. A radius of the second circle may be non-zero, which helps improve the compactness of the sensor unit.

The plurality of sensors may be angularly spaced over less than 90 degrees about the axis of rotation on the sensor unit. Thus, the fields of view of one or more of the rangefinder sensor, the one or more thermal imaging sensors and the one or more cameras can partially overlap to simplify calibration of the sensor apparatus.

The rangefinder sensor may be provided between the one or more thermal imaging sensors and the one or more cameras. The one or more cameras may be angularly spaced by less than 45 degrees from the rangefinder sensor in a plane transverse to the axis of rotation. The one or more cameras may be angularly spaced by less than 30 degrees from the rangefinder sensor in a plane transverse to the axis of rotation. A principal axis of the one or more cameras may be angularly spaced by less than 30 degrees from a principal axis of the rangefinder sensor in a plane transverse to the axis of rotation.

The one or more thermal imaging sensors may be angularly spaced by less than 45 degrees from the rangefinder sensor in a plane transverse to the axis of rotation. The one or more thermal imaging sensors may be angularly spaced by less than 30 degrees from the rangefinder sensor in a plane transverse to the axis of rotation. A principal axis of the one or more thermal imaging sensors may be angularly spaced by less than 30 degrees from a principal axis of the rangefinder sensor in a plane transverse to the axis of rotation.

Where the axis of rotation is substantially vertical, at least one of the plurality of sensors may be mounted to overhang a periphery of the sensor unit such that the at least one sensor is configured to capture sensor data associated with a region of the environment of the sensor apparatus substantially vertically below the at least one sensor, past the support structure. Thus, this ensures that the sensor apparatus can capture data even directly below the sensor unit. Therefore, a portion of the environment blocked by the presence of the sensor apparatus is reduced, and may even be almost entirely eliminated. At least one of the plurality of sensors may be arranged such that the principal axis of the at least one sensor is directed substantially downwards from the sensor apparatus.

Where the axis of rotation is not limited to being substantially vertical, a field of view of at least one of the plurality of sensors may encompass a first portion of the axis of rotation away from the sensor unit in a first direction and a second portion of the axis of rotation away from the sensor unit in a second direction opposite the first direction. Thus, a portion of the environment blocked by the presence of the sensor apparatus is reduced.

This in itself is believed to be novel and so, viewed from another aspect, the present disclosure provides a portable sensor apparatus for surveying a building. The sensor apparatus comprises a rotatable sensor unit for temporarily locating at the building. The rotatable sensor unit is configured to rotate about an axis of rotation. The rotatable sensor unit comprises at least one outwardly directed sensor mounted for rotation with the rotatable sensor unit to capture sensor data associated with an environment of the sensor apparatus. A field of view of the at least one sensor encompasses a first portion of the axis of rotation away from the sensor unit in a first direction and a second portion of the axis of rotation away from the sensor unit in a second direction opposite the first direction.

In some examples, the plurality of sensors may be arranged such that the principal axes of each of the plurality of sensors are parallel to each other. For example, the plurality of sensors may be arranged adjacent to each other and be orientated in the same direction. The plurality of sensors may be arranged on a planar front surface of the sensor unit, for example in a housing of the sensor unit.

In these examples, the field of view of the plurality of sensors overlap with each other, and in some examples each of the plurality of sensors have the same, or substantially the same, field of view. In particular, each of the rangefinder sensor, the thermal imaging sensor, and the camera may have the same field of view. As explained above, the thermal imaging sensor may comprise a plurality of thermal imaging sensors having different orientations. In this case, the combined field of view of the thermal imaging sensors is the combined field of view of the plurality of thermal imaging sensors. Similarly, the plurality of sensors may comprise a plurality of cameras, each having a different orientation. In this case, the field of view of the camera is the combined field of view of the plurality of cameras.

In these examples, the sensor unit may be moved by hand or by an actuator to provide a scanning motion. For example, the sensor unit may be mounted for rotation at a pivot for rotation about an axis transverse to the axes of the plurality of sensors, and the sensor unit can be tilted about the pivot. The sensor unit may also be mounted for rotation about a second axis, transverse to the pivot axis, so that the sensor unit can be moved in two rotational directions to provide a scanning motion.

In some examples, the scanning unit is manually moved through the scanning motion, for example the scanning unit may be hand-held and moved in a scanning motion to capture data. In these examples, the rangefinder sensor is preferably a steady state LiDAR rangefinder sensor.

The support structure may be configured for engagement with a ground surface, wherein the sensor unit is spaced from the ground surface by the support structure. In some examples, the sensor unit is mounted for rotation relative to the support structure. Thus, when the sensor apparatus is for surveying within the building, for example in a room of the building, the sensor unit is positioned off the ground, reducing the distance to a ceiling of the room. Furthermore, this ensures that the plurality of sensors of the sensor unit are positioned away from the ground surface, providing a more acute viewing angle from the plurality of sensors to a larger portion of the ground surface, particularly near the sensor apparatus, providing an improved spatial resolution of each of the one or more sensors when viewing the ground surface. The support structure may be a support tower. The support structure may have the sensor unit rotatably mounted thereto at a first end thereof. A second end of the support structure, opposite the first end may be provided with a ground engaging member, for engaging with the ground surface and supporting the sensor unit therefrom.

In some examples, the support structure is attachable to a drone for attachment of the sensor unit to the drone. The drone can be used for surveying parts of the building at height, or otherwise inaccessible, without a need for scaffolding or ladders. In this example, the drone can be remotely operated or autonomously operated to position the sensor unit for capturing scan data. The drone preferably comprises vertical lift generators, for example propellers rotating about a substantially vertical axis, such that the drone can maintain a hover position for capturing scan data. Preferably, the drone comprises a stabilising counter-balance to improve stability of the drone in movement and while hovering. In these examples, the sensor unit may be fixedly mountable to the drone, i.e. without the capability for the sensor unit to rotate relative to the drone. The drone can be controlled to rotate or move in order to provide a scanning motion for the sensor unit. The sensor unit can be fixedly mounted to the drone, or may be mounted at a pivot so that the orientation of the sensor unit can be adjusted before the drone is in flight.

In some examples, the support structure may comprise a handle for an operator to hold the sensor unit. Additionally or alternatively, the support structure may include a harness for attachment to an operator. Preferably, the support structure includes a gimbal or stabilizer to which the sensor unit is attached to steady the sensor unit. In some examples the operator can move the sensor unit to provide some, or all, of the scanning motion of the sensor unit for capturing scan data of the environment.

The support structure may comprise a plurality of support legs for supporting the sensor unit off the ground surface. Thus, the sensor apparatus can be fixedly positioned relative to the building, for example within the room of the building, to collect the sensor data. The support structure may comprise three support legs. Thus, the sensor apparatus can be stably sited on the ground surface. In some examples, the support structure comprises an extendible pole, for example a telescopic pole, and the sensor unit is attachable to an end of the extendible pole. The extendible pole may attach to a tripod for engagement with the ground. The extendible pole can be used for surveying parts of the building at height, or otherwise inaccessible, without a need for scaffolding or ladders.

In some examples, the support structure may comprise a suspended platform. The suspended platform may be used to lower the sensor apparatus from a fixed structure, for example a support structure may be suspended from one or more cables from the roof of a building and the descent of the platform can be controlled to scan an exterior of the building.

The support structure may comprise movement means configured to move the sensor apparatus over the ground surface. Thus, the sensor apparatus can move around to different positions and complete a number of scans in different locations relative to the building. The different locations may comprise locations within the building, for example in one or more rooms of the building. The different locations may comprise locations external to the building. The movement means may comprise wheels, for example ground-engaging wheels. The movement means may comprise one or more tracked units for movement over the ground surface. Alternatively, the sensor unit may be mounted to a flying vehicle or drone. It will be understood that other forms of movement means may be envisaged. The movement means may be motorised movement means for motorised movement of the sensor apparatus over the ground surface. To enable the sensor unit to be mounted on different support structures easily a quick release mechanism is envisaged. The sensor apparatus may comprise a quick release mechanism configured to connect the sensor unit to the support structure. Thus, the sensor unit can be easily moved to a different support structure as required. Viewed another way, the support structure can be suitable for connecting to a plurality of different sensor units, one at a time.

Information from the sensor unit of the sensor apparatus may be used in real time as the sensor unit is moved around to different locations associated with the building to enable localisation algorithms to be performed, e.g. using Simultaneous Localisation And Mapping (SLAM). For example, when an operator moves the sensor unit, information may be captured that enables the position of one scan relative to the next to be calculated. In an example, this information may be used by the movement means described previously to perform SLAM and enable autonomous route planning and navigation within the environment.

The support structure may be arranged to support the plurality of sensors more than 50 centimetres from the ground surface. Thus, the plurality of sensors is sufficiently spaced from the ground to ensure an adequate spatial resolution of the sensor data, even in relation to the ground surface in a vicinity of the sensor apparatus. The support structure may be arranged to support the plurality of sensors more than one metre from the ground surface. The support structure may be arranged to support the plurality of sensors less than two metres from the ground surface. When used outside, the support structure may be configured to support the plurality of sensors at the height of the building, for example using an extendable pole attached to a sturdy base or a flying vehicle such as a drone.

A length of the support structure may be adjustable. Thus, a user of the sensor apparatus can control a spacing of the plurality of sensors from the ground surface. This can be useful for transport of the sensor apparatus, or for use of the sensor apparatus in different environments of the building, for example in rooms of different sizes. The length of the support structure may be associated with the height of the sensor unit off the ground surface. The length of the support structure may be extensible, for example telescopically extensible.

The sensor unit may be configured to be removably attached to the support structure. Thus, during transport, the sensor unit can be removed from the support structure and re-assembled on site using a quick release mechanism. Alternatively, different sensor units can be mounted on the support structure depending on the room and the survey requirements. For example, different sensor units may comprise a different collection of sensors.

In some examples, the portable sensor apparatus may additionally comprise one or more further sensors comprising one or more of a temperature sensors, a humidity sensor, a carbon dioxide sensor, and/or an air particulate sensor. The temperature sensor may be mounted inside the sensing unit and used to monitor the internal temperature in order to calibrate the sensors. The internal temperature may be calibrated by referring to a database, for example through a software look-up table. Alternatively, the sensors may be mounted so as to monitor the ambient conditions of the environment being surveyed. At least one of the further sensors may be separate to the sensor unit. For example, at least one of the further sensors may be provided in a further sensor device, for capturing data remote from the sensor unit. For example, the further sensor device may comprise a temperature sensor for capturing an external temperature, or a humidity sensor for detecting humidity proximate to a wall. In other examples, the one or more further sensors are disposed in the sensor unit.

The sensor apparatus may further comprise a controller to control the plurality of sensors to capture the sensor data during the scanning motion of the sensor unit, for example during rotation of scanning unit. Thus, a user can operate the sensor apparatus via the controller. In examples where the sensor unit is rotatable, the controller may be configured to control the sensor unit to rotate such that the plurality of sensors is arranged to capture the sensor data associated with 360 degrees of the environment of the sensor apparatus. Thus, from a single location of the sensor apparatus, sensor data associated with an entire room can be collected, apart from any objects in the room not visible from the single location. It will be understood that the sensor apparatus can of course be moved to one or more further locations in the room to capture a full set of sensor data associated with the room. The controller may be configured to control the sensor unit to rotate through 360, 180, 90 degrees, or an alternative user selected angle. The controller may be configured to control the speed and quality of the scan so the user can select whether a low quality, quick scan or slow, high quality scan is preferable.

The sensor apparatus may further comprise a wireless transmitter, for example a wireless transceiver configured to be in wireless communication with a further device. The controller may be configured to output sensor data from the plurality of sensors to the further device via the wireless transceiver. Thus, the sensor data can be exported from the sensor unit. The further device may be separate to the sensor apparatus. Alternatively, the further device may be part of the sensor apparatus, separate from the sensor unit. The further device may be a mobile device for example a tablet, a mobile phone or a laptop device. A user may control the sensor unit using an application running on the mobile device or by sending commands directly to the sensor unit.

The sensor apparatus may be configured to combine the sensor data output from each of the rangefinder sensor, the one or more thermal sensors and the one or more cameras to provide a combined data set indicative of the environment of the sensor apparatus. Thus, data from each of the plurality of sensors can be fused into a single dataset such that there is data indicative of the optical characteristics, the depth position and thermal characteristics of any of the regions sensed by the sensor apparatus. In an example, the combination of the sensor data may be performed by the controller of the sensor apparatus. The controller may be housed in the sensor unit. Alternatively, the combination of the sensor data into the combined data set may be performed on a further device.

The combined data set may comprise one or more damp readings. The combined data set may comprise temperature information. The combined data set may comprise services information. The combined data set may comprise condition information of one or more objects associated with the building, for example with a room. The combined data set may comprise moisture information. The combined data set may comprise construction information. The combined data set may comprise thermal efficiency information, for example a U-value calculated from the physical properties detected in the environment. The combined data set may comprise size information of one or more objects associated with the building, for example with a room. The combined data set may comprise energy efficiency information. The combined data set may comprise cost information. The cost information may be associated with an energy running cost of the building. The cost information may be associated with the cost of remedial, maintenance or upgrade works based on properties of the data set.

In preferred examples, the sensor unit may comprise a rangefinder sensor and a plurality of thermal imaging sensors. In these examples, the field of view of each thermal imaging sensor may overlap the field of view of the rangefinder sensor, and the field of view of each thermal imaging sensor may overlap a field of view of at least one of the other thermal imaging sensors. Such an arrangement is advantageous for calibrating the thermal imaging sensors based on thermal data values captured by more than one thermal imaging sensor.

The sensor apparatus may comprise any one or more of the plurality of sensors described hereinbefore.

Viewed from another aspect, the present disclosure provides a method of managing a record of a state of a building. The method comprises: positioning the sensor apparatus as described hereinbefore in a room of a building; activating the sensor apparatus to capture sensor data from each of the plurality of sensors of the sensor apparatus, the sensor data being indicative of the environment of the sensor apparatus in the room; moving the sensor unit through a scanning motion; combining the sensor data from each of the plurality of sensors of the sensor apparatus into a combined data set; and storing the combined data set in a database associated with the building as a record of a state of the building.

Thus, there is provided a method of using the sensor apparatus described hereinbefore to assess the state of a room.

The method may further comprise attaching tags to one or more objects in the environment of the sensor apparatus prior to capturing the sensor data. Thus, it is possible to label objects in the environment of the sensor apparatus depending on the type of object and how they are to be treated by the sensor apparatus. The tags may be in the form of stickers configured to be attached to one or more elements in the environment of the sensor apparatus. The tags may be recognised from the data set captured by the sensor apparatus. Alternatively, an operator may label elements using an application running on a mobile device. As multiple data sets are captured from different buildings these labels may be used by machine learning algorithms to recognise objects, materials and features within the room with increasing accuracy. Thus, the sensor apparatus may be configured to determine a category of one or more objects in the environment in dependence on the combined sensor data and a machine learning algorithm, trained on one or more previously-labelled datasets.

The sensor apparatus may be configured to capture the sensor data including tag data indicative of the tags. The combined data set may be determined in dependence on the tag data. Thus, the tag data can be used, for example, to label some portions of the combined data set, or for example to exclude portions of the sensor data from the combined data set. This may be desirable to remove personal details and objects from the combined data set which are not needed or would create privacy issues when shared with other stakeholders.

The method may further comprise determining a mold presence indicator associated with one or more regions of the room in dependence on the sensor data from the plurality of sensors. The method may further comprise determining a damp reading associated with one or more regions of the room in dependence on the sensor data from the plurality of sensors. The mold presence indicator may be indicative of a risk of mold and may be determined based on the physical properties of the surface including it's temperature and moisture content, which can then be combined with environmental properties including air temperature and humidity to calculate the risk of condensation and mold growth from known properties contained in a look up table. The moisture content of the material may be determined based on the reflectivity of the surface, it's surface temperature and visual characteristics or through the use of a separate additional sensor, e.g. handheld damp meter, as described elsewhere herein.

The sensor apparatus may comprise at least one of a carbon dioxide sensor, an air temperature and humidity sensor to capture environmental conditions of the environment of the sensor apparatus. The carbon dioxide sensor, air temperature sensor, and/or humidity sensor may be provided in the sensor unit, or may be provided separately.

The sensor apparatus may be for use in a room of a building. Alternatively or additionally, the sensor apparatus may be for use monitoring an outside of a building. Thus, the sensor apparatus can be used for surveying spaces both internal and external.

The portable sensor apparatus may comprise a further sensor device for temporarily locating at the building, separate from the sensor unit. The further sensor device may comprise: at least one sensor configured to sense a characteristic of an environment of the further sensor device; and a locating tag, configured to be detectable by at least one of the sensors of the sensor unit. Thus, the locating tag can be detected by at least one of the sensor(s) of the sensor unit to locate the further sensor device in the environment sensed by the sensors of the sensor unit. Therefore, the sensor output from the at least one sensor of the further sensor device can be accurately associated with a location in the sensor output from the plurality of sensors in the sensor unit.

The present disclosure extends to a sensor unit adapted to be the further sensor device.

The locating tag may be a reflector, for example a retroreflector configured to reflect laser light received from the laser rangefinder. The portable sensor apparatus may be configured to determine the location of the further sensor device in the environment based on the sensor data from the plurality of sensors of the sensor unit.

The further sensor device may be, for example, a hand-held meter or a separate meter for mounting on a wall, such as the wall of a room, for example a radar sensor, moisture sensor or spectrometer for detecting materials and their properties. The further sensor device may comprise attachment means, for example in the form of a suction cup configured to temporarily secure the further sensor device to the wall. The further sensor device may comprise at least one sensor, for example a damp sensor provided on a rear surface thereof for facing the wall of the room when the further sensor device is mounted on the wall of the room. Thus, the further sensor device can be used to determine a damp reading associated with a wall of the room. The damp sensor may be arranged to contact the wall when the further sensor device is mounted on the wall of the room. The at least one sensor may comprise a temperature sensor for measuring a temperature of the room. The further sensor device may comprise a locating tag, for example a reflector, such as a lidar reflector or a retroreflector. The lidar reflector may be configured to reflect laser signals from the laser rangefinder sensor of the sensor unit. In this way, the position of the further sensor device in the room can be determined by the sensor apparatus based on the sensor data of the sensor unit. Alternatively, the operator may manually locate the further sensing device by selecting a location in a representation of the environment of the sensor apparatus, for example the room, shown on an application running on a mobile device, created from the data set generated following a scan using the sensor unit. In embodiments, the further sensor device may comprise a communications unit, for example a wireless communications unit for outputting sensor data from the at least one sensor of the further sensor device away from the further sensor device, for example to the sensor unit or to a further device in data communication with the further sensor device and the sensor unit. Sensor data from the further sensor device may be used to calibrate the readings from the sensor unit of the sensor apparatus.

In accordance with another aspect of the present disclosure, there is also provided a method of calibrating a portable sensor apparatus for surveying a building. The sensor apparatus of these examples comprises a rangefinder sensor adapted to capture range data for surfaces in the environment of the sensor apparatus, and first and second thermal imaging sensors adapted to capture thermal data of the surfaces in the environment of the sensor apparatus. The first and second thermal imaging sensors having at least partially overlapping fields of view. The method of calibrating the portable sensor apparatus comprises: combining the range sensor data and the thermal sensor data into a combined data set representative of the surfaces of the environment of the sensor apparatus; identifying a surface point in the combined data set where both of the first thermal imaging sensor and the second thermal imaging sensor have captured thermal data; determining a calibration factor configured to calibrate the first thermal imaging sensor and/or the second thermal imaging sensor; and applying the calibration factor to the thermal data of at least one of the first thermal imaging sensor and the second thermal imaging sensor.

The method may further include determining a difference between the thermal data of the first thermal imaging sensor at the identified surface point and the thermal data of the second imaging sensor at the identified surface point.

In this way, the thermal imaging sensors can be calibrated to each other based on surface points in the environment of the portable sensor apparatus that are detected by more than one thermal imaging sensor.

The combined data set is preferably a point cloud model of the environment of the portable sensor apparatus comprising a plurality of points, each representative of a surface point in the environment and comprising range data from the rangefinder sensor and at least one thermal data value from the thermal imaging sensors.

The method may further comprise: identifying a plurality of surface points in the combined data set where both of the first thermal imaging sensor and the second thermal imaging sensor have captured thermal data; and, determining a calibration factor configured to minimise the differences between the thermal data of the first thermal imaging sensor at the identified surface point and the thermal data of the second imaging sensor at each of the identified surface point.

In some examples, the step of determining a calibration factor comprises use of a matrix form least squares method. Such a method allows for the calibration factor to be determined based on all thermal data values by minimising the error vector of thermal readings from surface points where more than one thermal imaging sensor has captured thermal data.

### BRIEF DESCRIPTION OF THE DRAWINGS

Embodiments of the invention are further described hereinafter with reference to the accompanying drawings, in which:

FIG. 1 is a perspective illustration of an exemplary portable sensor apparatus;

FIG. 2 is a frontal illustration of a rotatable sensor unit;

FIGS. 3 and 4 are perspective illustrations of the rotatable sensor unit;

FIG. 5 is a plan view of an arrangement of sensors within the rotatable sensor unit;

FIG. 6 is a side view of an arrangement of thermal imaging sensors within the rotatable sensor unit;

FIG. 7 is a side view of an arrangement of the cameras within the rotatable sensor unit;

FIGS. 8A, 8B and 8C show a further example portable sensor apparatus;

FIG. 9 is a perspective illustration of an alternative portable sensor apparatus;

FIG. 10 is a perspective illustration of an alternative portable sensor apparatus FIG. 11 is a perspective illustration of an alternative portable sensor apparatus;

FIG. 12 is a perspective illustration of an alternative portable sensor apparatus;

FIG. 13 is a perspective illustration of an alternative portable sensor apparatus

FIG. 14 is a plan view of a room with the portable sensor apparatus situated therein;

FIGS. 15A and 15B are illustrations of a further sensor device for the portable sensor apparatus;

FIG. 16 is a schematic diagram showing the sensor apparatus of any of FIGS. 1 to 15B, a tablet computer, and a data connection;

FIGS. 17A, 17B and 17C illustrate an example portable sensor apparatus, showing the fields of view of the rangefinder sensor and the thermal imaging sensors; and

FIG. 18 is a schematic illustration of a method of calibrating the thermal imaging sensors of a portable sensor apparatus.

### DETAILED DESCRIPTION

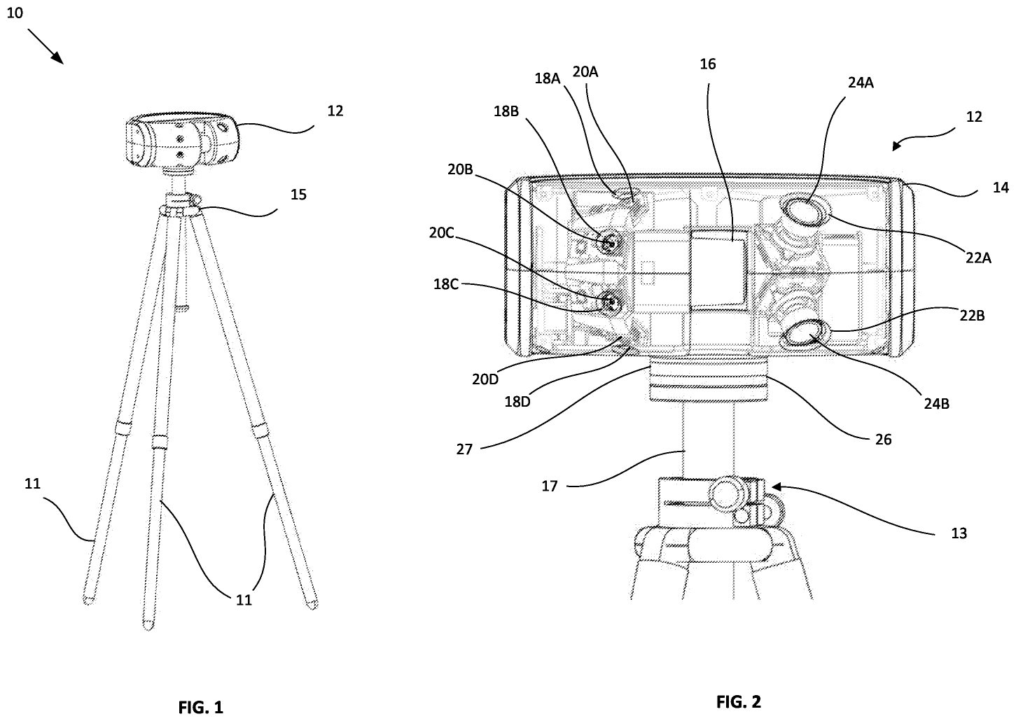

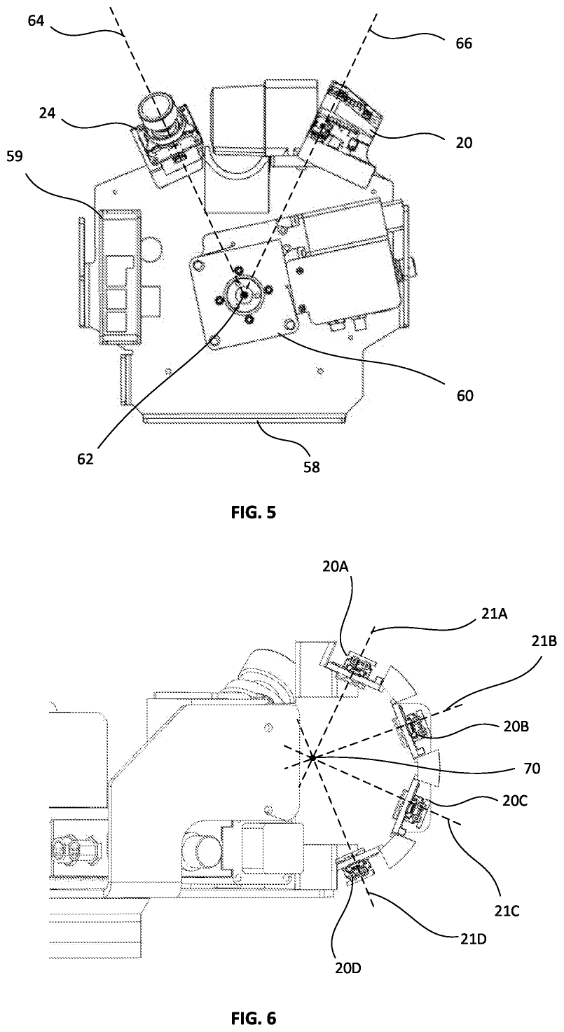

FIG. 1 is a perspective illustration of an exemplary portable sensor apparatus 10. In the illustrated example, the sensor apparatus 10 includes a sensor unit 12 mounted to a support structure that is for engaging with the ground and spaces the sensor unit 12 from the ground. In the illustrated example, the support structure is a tripod 15 that has extendable legs 11 in contact with the ground. The sensor unit 12 houses different sensors that sense different aspects of the environment surrounding the sensor apparatus 10. By mounting the sensor unit 12 to the tripod 15, the sensor unit 12 can be spaced from the ground to facilitate scanning of the surrounding environment. In one example, the sensor unit 12 is spaced 50 cm to 2 m from the ground, for example approximately 1 metre from the ground. However, it would be apparent that the sensor unit 12 may be spaced by less than 50 cm or by more than 2 m depending on the environment to be scanned. The tripod legs 11 may be telescopic to allow a user to easily change the height of the sensor unit 12 and to aid transportation of the sensor apparatus 10 to a location. Additionally, the tripod 15 has a bracket 17 to connect to a base portion 26 of the sensor unit 12 (see FIG. 2). The bracket 17 preferably includes a release mechanism to allow for separation of the base portion 26 from the tripod 15. The release mechanism may include a quick release lever, one or more screws, sprung arrangements or similar arrangements known in the art. In the illustrated example, the tripod 15 has an adjustable clamp 13 to facilitate adjustment of the bracket 17 about and/or along the vertical direction. For example, the adjustable clamp 13 can be used for fine adjustments of the rotational position of the sensor unit 12 as well as the height of the sensor unit 12. In the illustrated example, a motorised stage 60 (see FIG. 5) is used to rotate the sensor unit 12 about an axis of rotation 62 (see FIG. 5). The rotating stage 60 preferably has the ability to rotate the sensor unit 12 through 360 degrees with respect to the tripod 15. The axis of rotation 62 is preferably substantially vertical.

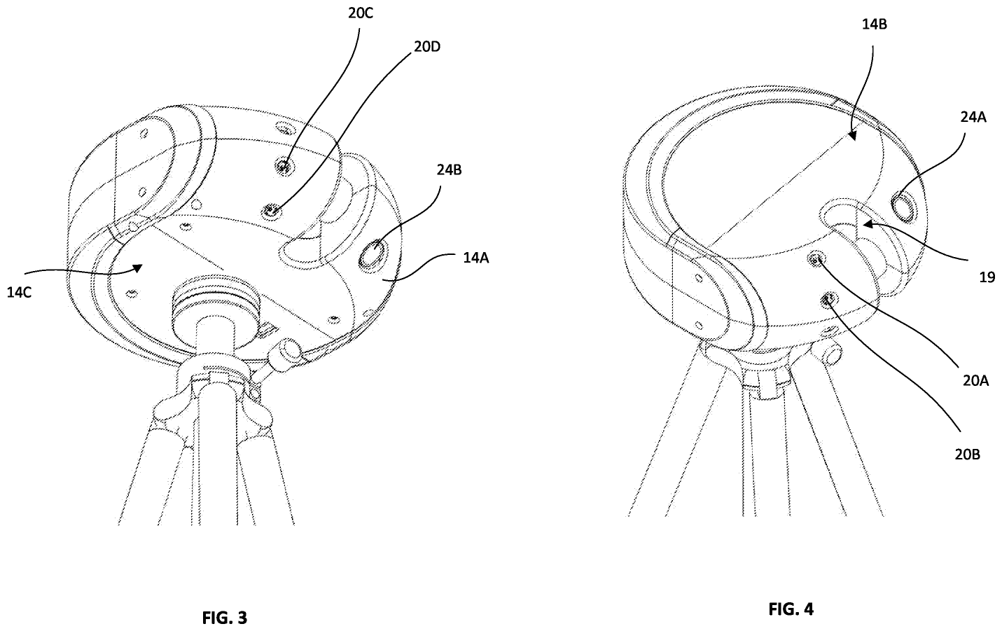

The sensor unit 12 has a housing 14 which comprises an arrangement of sensors 20, 16, 24. In one example, the arrangement of sensors includes a thermal imaging sensor 20, a laser rangefinder 16, and an optical camera 24, for example an RGB camera 24. The thermal imaging sensor 20 and optical sensor 24 in the form of a camera 24 are arranged to provide a wide field of view of the environment being scanned (see also FIGS. 3 and 4). In the illustrated example, the housing 14 has a front surface 14A (shown as partially transparent in FIG. 2 for ease of illustration), a top surface 14B and a bottom surface 14C. The housing 14 has multiple ports 18, 22 formed therein for the thermal imaging sensor 20 and camera 24 to view the environment surrounding the sensor unit 12. In the illustrated example, the sensor unit 12 has four thermal imaging sensors 20A, 20B, 20C, 20D, two optical cameras 24A, 24B and one laser rangefinder 16.

The front surface 14A of the housing has corresponding ports 18, 22 for each of the cameras 24 and thermal imaging sensors 20A, 20B, 20C, 20D. In the illustrated example, the thermal imaging sensors 20 are arranged in a first plane 66, the cameras 24 are arranged in a second plane 64 and the laser rangefinder 16 is secured within a recess 19 (see FIG. 4) of the housing 14 between the cameras 24 and thermal imaging sensors 20. The first vertical plane of the thermal imaging sensors 20 and the second vertical plane of the cameras 24 form an acute angle with a scanning plane of the laser rangefinder 16. The first and second vertical planes are preferably vertical. In one example, the first plane 66 may be offset from the scanning plane by 25 degrees in one direction and the second plane may be offset from the scanning plane by 25 degrees in a second direction opposite the first direction. Arranging the sensors in this manner is advantageous, as the fields of view of the thermal imaging sensors 20 and the laser rangefinder 16 can overlap and the fields of view of the cameras 24 and the laser rangefinder 16 can overlap. The field of view of the thermal imaging sensors 20A, 20B, 20C, 20D and optical cameras 20 may be different. In one example, one or more of the thermal imaging sensors 20A, 20B, 20C, 20D has a diagonal field of view of 71 degrees and a horizontal field of view of 57 degrees. In another example, one or more of the optical cameras 24 has a lens with diagonal field of view of 126 degrees, a horizontal field of view of 101 degrees and a vertical field of view of 76 degrees.

The housing 14 is arranged such that one or more of the sensors are secured horizontally beyond an outermost edge the bottom surface 14C to provide an unobstructed view for the sensors capturing data below the sensor unit 12. The housing 14 is also arranged such that one or more of the sensors are secured horizontally beyond an outermost edge of the top surface 14B to provide an unobstructed view for the sensors capturing data above the sensor unit 12. Arranging the housing 14 in this manner enables data to be captured from directly above and/or beneath the sensor unit 12. In the illustrated example, thermal imaging sensors 20A and 20B and camera 24A capture data in front of and above the sensor unit 12, while thermal imaging sensors 20C and 20D and camera 24B capture data in front of and below the sensor unit 12. While two thermal imaging sensors 20A, 20B are used to capture an upper region of the room, it would be apparent that a single sensor with a sufficiently wide field of view may be used to capture the upper region. In some cases, one thermal imaging sensor with a sufficiently wide field of view may be sufficient to measure data from the region in front of the sensor unit 12. While two cameras 24 have been described, it would be apparent that one camera having a sufficiently wide field of view may be used to view the entire region in front of the sensor unit 12. The base portion 26 in this example includes a light bar 27 to illuminate the region below the sensor unit 12.

The laser rangefinder 16 preferably has a field of view of greater than 180 degrees. Therefore, as the sensor unit 12 rotates through 360 degrees, the laser rangefinder 16 can capture spatial data of the entire room. Once the sensor unit 12 has rotated through 360, a complete data set of the room including multiple types of data corresponding to each of the sensors will be captured. While one particular sensor arrangement has been described, it would be apparent that this arrangement is not essential and that the sensors and/or housing 14 may be arranged differently while still providing the requisite coverage. It would also be apparent that more or fewer thermal imaging sensors 20A, 20B, 20C, 20D and cameras 24A, 24B may be used to capture the required data.

FIG. 5 is a plan view of an arrangement of sensors within the sensor unit 12. In the illustrated example, the thermal imaging sensors 20, laser rangefinder 16 and cameras 24 are mounted to a frame 58 of the sensor unit 12. As described above, the thermal imaging sensors 20 are arranged in a first plane 66, the cameras 24 are arranged in a second plane 64 and the laser rangefinder 16 is mounted between the two planes 64, 66. It is preferable that the first 66 and second 64 planes intersect the axis of rotation 62 of the sensor unit 12 as illustrated in FIG. 5 so that each sensor will capture data from the same perspective.

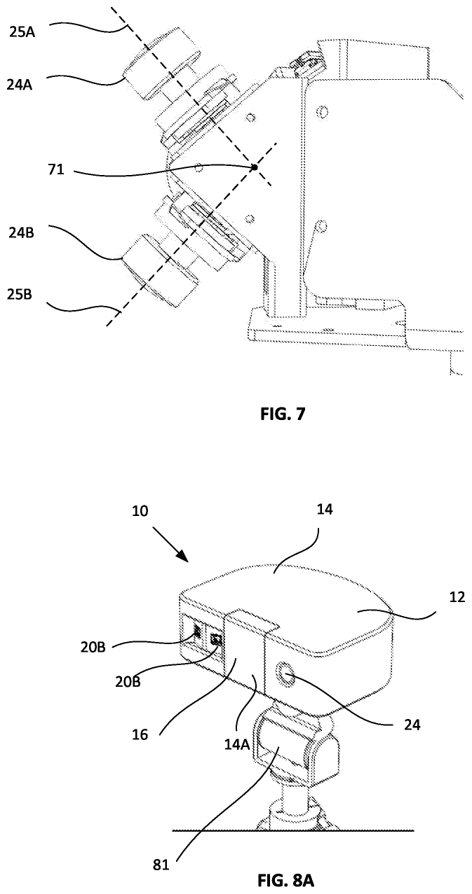

As shown in FIG. 6, each thermal imaging sensor 20A, 20B, 20C, 20D has an associated principal axis 21. In the illustrated example, the thermal imaging sensors 20A, 20B, 20C, 20D are arranged such that the respective principal axes 21A, 21B, 21C and 21D intersect a first virtual line circumscribing the axis of rotation 62. The first virtual line may be transverse to the axis of rotation 62. In this case, the principal axes 21A, 21B, 21C and 21D would intersect the rotational axis 62 and the first virtual line. In one example, the respective principal axes 21A, 21B, 21C and 21D are arranged in a radial manner and intersect a mutual point 70. Preferably, the first virtual line is centred about the axis of rotation 62 and has a radius equal to the perpendicular distance between the axis of rotation 62 and mutual point 70. As shown in FIG. 7, each camera 24A, 24B has an associated principal axis 25 and cameras 24A and 24B may be arranged such that the respective principal axes 25A and 25B intersect a second virtual line circumscribing the axis of rotation 62. The first virtual line may be transverse to the axis of rotation 62. In this case, the principal axes 25A and 25B would intersect the rotational axis 62 and the second virtual line. In one example, the respective principal axes 25A and 25B are arranged such that the principal axes 25A and 25B pass through a mutual point 71. Preferably, the second virtual line is centred about the axis of rotation 62 and has a radius equal to the perpendicular distance between the axis of rotation 62 and mutual point 71. By arranging the thermal imaging sensors 20A, 20B, 20C, 20D and cameras 24A and 24B in this way, the combined thermal imaging data and camera can be captured from a common perspective. The illustrated arrangement of thermal imaging sensors 20 has a collective field of view of at least 180 degrees. The illustrated arrangement of optical cameras 24 has a collective field of view of at least 180 degrees. The illustrated arrangement of the laser rangefinder 16 has a field of view of at least 180 degrees. The collective fields of view of the laser rangefinder 16, the thermal imaging sensors 20 and the optical cameras 24 may be different from one another. In the illustrated example, the sensors are located at the periphery of the housing 14 and the thermal imaging sensors 20 and optical cameras 24 view the environment through respective ports 18, 22 and the laser rangefinder is located in recess 19. The respective ports 18, 22 and recess 19 will limit the field of view of the respective sensor. In this case, data can only be captured from a minimum distance above and below the top 14B and bottom 14C surfaces. The distance from the top surface 14B above which data can be captured may be different to the distance from the bottom surface 14C beyond which data can be captured. By locating the sensors at the periphery of the sensor unit 12 the legs 11 of the tripod 15 will also occlude less of the environment being recorded by the sensors.

The sensor unit 12 is preferably calibrated at least once before deployment. This allows for accurate sensor measurement, taking account of any manufacturing tolerances of the housing 14 or frame 58 affecting the precise positions of the sensors, and to account for any variations in sensing components or lenses. The calibration process helps to ensure the captured data is accurate and allows for corrections to be applied prior to capturing any field data. Calibration may also be used to correct for temperature of the environment. For example, it will be understood that variations in the temperature of the environment of the sensor apparatus can result in changes in the physical dimensions of one or more components of the sensor apparatus. One method of calibrating the cameras 24A, 24B is to use a calibration grid. Typically, a calibration grid includes contrasting shapes of different known sizes and relative position displayed on a surface. In one example, these can take the form of multiple black squares printed on a white board and placed at a predetermined or otherwise accurately determinable location relative to the sensor unit 12. In one example, calibration of the thermal imaging sensors 20A, 20B, 20C, 20D involves directing the thermal imaging sensors 20 towards multiple thermal surfaces and selectively bringing the thermal surfaces to one or more known temperatures. As the temperature of the thermal surfaces changes, the thermal imaging sensors 20 detect the thermal surfaces and the changes and this data is used to calibrate the thermal imaging sensors 20A, 20B, 20C, 20D. In one example, calibration of the laser rangefinder 16 may be performed by mounting the sensor unit 12 a known distance from a target. The laser rangefinder 16 can then capture data indicating a measured distance to the target and apply any correction factors. In one example, the laser rangefinder 16 may be calibrated prior to the thermal imaging sensors 20 and the optical cameras 24. In this case, the thermal imaging sensors 20 can detect the thermal surfaces and relate the locations of the thermal surfaces with the depth data captured by the laser rangefinder 16. Once the thermal imaging sensors 20 have been calibrated, the sensor unit 12 may rotate about the vertical axis 62 and face the calibration grid. The cameras 24 can then be calibrated using the calibration grid and relate the locations of the calibration grid with the depth data captured by the laser rangefinder 16. While separate calibration of the thermal imaging sensors 20 and optical cameras 24 has been described, it would be apparent this need not be the case, and two or more of the sensors may be calibrated using a single surface without needing to rotate the sensor unit 12.

A wireless transceiver 59 (see FIG. 5) and controller (not shown) are also mounted to the frame 58. The wireless transceiver 59 allows the sensor unit 12 to be in wireless communication with a further device, for example a mobile device, such as a tablet computer, or a server. This enhances the portability of the sensor apparatus 10, as user can simply pick up and move the sensor apparatus 10 from room to room without worrying about trailing cables. Once data is captured by the sensor unit 12 it can be transmitted to the further device for storage or processing. In one example, the wireless transceiver 59 is a wireless router. In one example, the further device may be part of the sensor apparatus 10 or may be a remote device separate to the sensor apparatus 10. The controller or further device may be configured to process the captured data from the laser rangefinder 16, thermal imaging sensors 20 and cameras 24 and to provide the complete dataset of the scanned environment. In one example, data processing may happen offline, for example on the mobile device or the server.

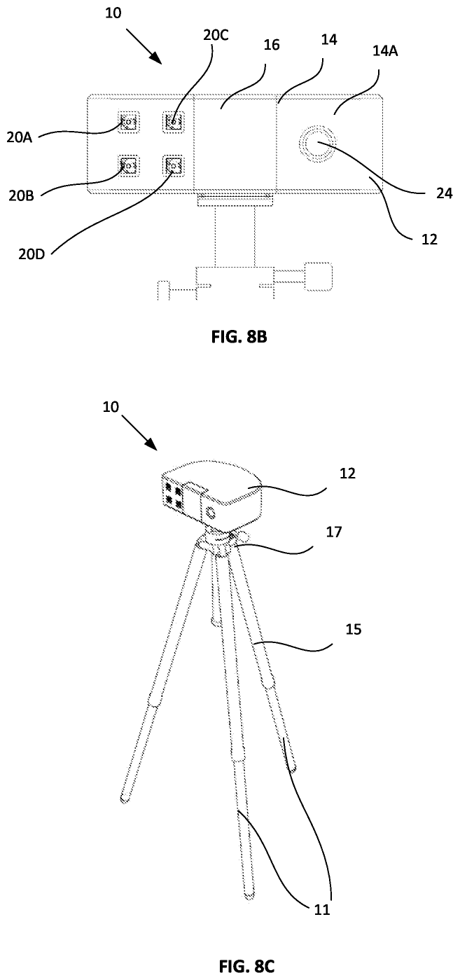

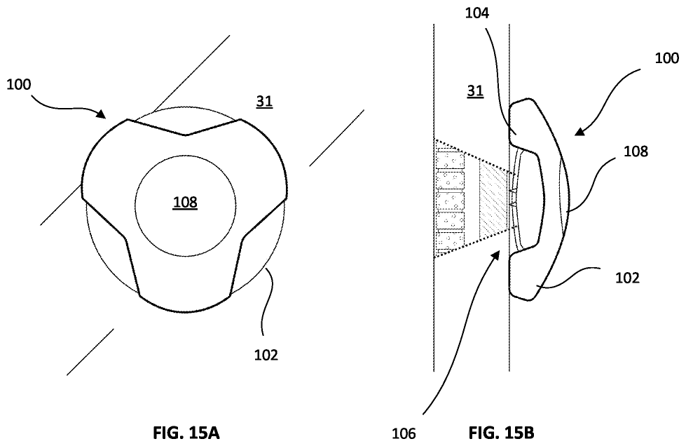

FIGS. 8A, 8B and 8C illustrate an alternative example portable sensor apparatus 10. In this example, the sensor apparatus 10 includes a sensor unit 12 mounted to a support structure that is for engaging with the ground and spaces the sensor unit 12 from the ground. In the illustrated example, the support structure is a tripod 15, as illustrated in FIG. 15, that has extendable legs 11 in contact with the ground. The sensor unit 12 houses different sensors that sense different aspects of the environment surrounding the sensor apparatus 10. By mounting the sensor unit 12 to the tripod 15, the sensor unit 12 can be spaced from the ground to facilitate scanning of the surrounding environment. In one example, the sensor unit 12 is spaced 50 cm to 2 m from the ground, for example approximately 1 metre from the ground. However, it would be apparent that the sensor unit 12 may be spaced by less than 50 cm or by more than 2 m depending on the environment to be scanned. The tripod legs 11 may be telescopic to allow a user to easily change the height of the sensor unit 12 and to aid transportation of the sensor apparatus 10 to a location. Additionally, the tripod 15 has a bracket 17 to connect to the sensor unit 12 (see FIG. 2). The bracket 17 preferably includes a release mechanism to allow for separation of the sensor unit 12 from the tripod 15. The release mechanism may include a quick release lever, one or more screws, sprung arrangements or similar arrangements known in the art. The tripod 15 may have an adjustable clamp to facilitate adjustment of the bracket 17 about and/or along the vertical direction. For example, the adjustable clamp can be used for fine adjustments of the height and rotational position of the sensor unit 12.

In the illustrated example, the sensor unit 12 is rotatable about a horizontal axis at pivot 81, which preferably includes a clamp for securing the rotational position of the sensor unit about the horizontal axis. The sensor unit 12 can also be rotated about a vertical axis by adjustment of the adjustable clamp at bracket 17. Therefore, the sensor unit 12 can be positioned with a desired field of view by moving the tripod 15 and then adjusting the position of the sensor unit 12 by using the clamps of the pivot 81 and the bracket 17.

The sensor unit 12 has a housing 14 which comprises an arrangement of sensors 20, 16, 24. In one example, the arrangement of sensors includes a thermal imaging sensor 20, a laser rangefinder 16, and an optical camera 24, for example an RGB camera 24. The thermal imaging sensor 20, the optical sensor 24 in the form of the camera 24, and the laser rangefinder 16 are arranged in the same plane, having parallel principal axes, to provide a field of view of the environment in front of the scanning unit 12.

In the example of FIG. 8A, the sensor unit 12 has two thermal imaging sensors 20A, 20B, one optical camera 24, and one laser rangefinder 16. The front surface 14A of the housing has ports for the camera 24 and the thermal imaging sensors 20A, 20B. As illustrated, the thermal imaging sensors 20A, 20B are angled with respect to one another such that a combined field of view of the two thermal imaging sensors 20A, 20B provide a combined field of view.

In this example, the fields of view of the laser rangefinder sensor 16, the camera 24, and the combined field of view of the thermal imaging sensors 20A, 20B are substantially the same, for example the same field of view. That is, each of the sensors 20A, 20B, 16, 24, is configured to scan the same area of the environment for any given position of the sensor unit 12.

Alternatively, in this example the laser rangefinder sensor 16, the camera 24, and the combined field of view of the thermal imaging sensors 20A, 20B each have overlapping fields of view. Specifically, the combined field of view of the thermal imaging sensors 20A, 20B overlaps the field of view of the laser rangefinder 16 and the field of view of the camera 24, the field of view of the camera 24 overlaps the field of view of the laser rangefinder 16 and the combined field of view of the thermal imaging sensors 20A, 20B, and the field of view of the laser rangefinder 16 overlaps the combined field of view of the thermal imaging sensors 20A, 20B and the field of view of the camera 24. Providing overlapping fields of view in this way makes it easier to combine the data from the different sensors.

FIG. 8C illustrates an alternative example in which the sensor unit 12 comprises four thermal imaging sensors 20A, 20B, 20C, 20D arranged to provide a combined field of view that matches or overlaps the fields of view of the laser rangefinder sensor 16 and the camera 24. Providing more thermal sensor units may provide higher resolution thermal imaging.

In contrast to the example sensor unit 12 of FIGS. 1 to 7, the sensor unit 12 of FIGS. 8A to 8C does not include a motorised rotational mounting. The sensor unit 12 of FIGS. 8A to 8C may therefore be better adapted to capture scan information of a planar feature arranged only in one direction relative to the sensor unit 12, for example an external wall of a building. To capture scan data using the sensor unit of FIGS. 8A to 8C, the user can position the scanning apparatus 10 in front of the object to be scanner, direct the sensor unit 12 towards the object, activate the sensors 20, 16, 24 and then tilt the sensor unit 12 about the horizontal axis using the pivot 81, in an up-and-down motion. For wider objects, the scanning apparatus 10 can be moved sideways by moving the tripod 15, or the scanning unit 12 may be rotated on the tripod 15, or the tripod 15 can be rotated. Preferably, the sensor unit 12 or the pivot 81 includes a handle for the user to use to move the sensor unit 12 about the horizontal axis.

In this example, the laser rangefinder 16 preferably comprises a solid state LiDAR rangefinder. A solid state LiDAR rangefinder 16 will be less susceptible to motion of the sensor unit 12, and so is better suited to applications where a less controlled motion of the sensor unit 12 is employed during the scanning motion. As described above, the steady state LiDAR rangefinder 16 has a field of view that matches or overlaps the field of view of the thermal imaging sensor 20 and the camera 24. In this way, the sensor data captured by the three sensors 20, 16, 24 can be more easily processed to match the corresponding locations of each scan.

While one particular sensor arrangement has been described, it would be apparent that this arrangement is not essential and that the sensors and/or housing 14 may be arranged differently while still providing the requisite coverage. It would also be apparent that more or fewer thermal imaging sensors 20 and cameras 24 may be used to capture the required data, provided that the combined fields of view of the multiple thermal imaging sensors and/or multiple cameras provides a matching or overlapping field of view for the other sensors, including the laser rangefinder 16.

The sensor unit 12 is preferably calibrated at least once before deployment. This allows for accurate sensor measurement, taking account of any manufacturing tolerances of the housing 14 affecting the precise positions of the sensors, and to account for any variations in sensing components or lenses. The calibration process can be performed in the same manner as described previously.

The sensor unit 12 also includes a wireless transceiver (not shown) and controller (not shown). The wireless transceiver allows the sensor unit 12 to be in wireless communication with a further device, for example a mobile device, such as a tablet computer, or a server. This enhances the portability of the sensor apparatus 10, as user can simply pick up and move the sensor apparatus 10 from room to room without worrying about trailing cables. Once data is captured by the sensor unit 12 it can be transmitted to the further device for storage or processing. In one example, the wireless transceiver is a wireless router. In one example, the further device may be part of the sensor apparatus 10 or may be a remote device separate to the sensor apparatus 10. The controller or further device may be configured to process the captured data from the solid state LiDAR rangefinder 16, thermal imaging sensor 20 and camera 24 and to provide the complete dataset of the scanned environment. In one example, data processing may happen offline, for example on the mobile device or the server.

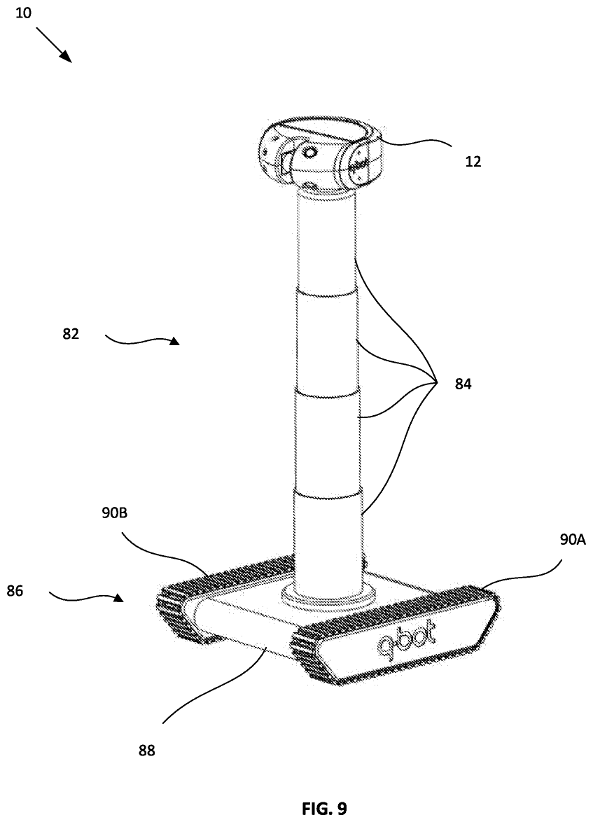

FIG. 9 is a perspective illustration of an alternative sensor apparatus 10. In this example, the sensor apparatus 10 includes a sensor unit 12 that may be the sensor unit described with reference to any of FIGS. 1 to 8C, and a support structure 82. The support structure 82 includes a number of tower elements 84 for mounting to a base 86 at a first end and the sensor unit 12 at a second end. The tower elements 84 allow the sensor unit 12 to be spaced from the ground at a desired height. The tower elements 84 allow the sensor unit 12 to be rotated to point in a desired direction. The tower elements 84 are preferably telescopic. In one example, the tower elements 84 are motorised. In this case the motorised tower elements 84 can be driven to change the height and/or direction of the sensor unit 12. In one example, the base 86 includes movement means to drive the sensor apparatus 10 over ground. In the illustrated example, the movement means includes a connecting member 88 and motorised tracks 90A, 90B. While tracks 90A, 90B are illustrated it would be apparent that wheels or other such members may be used to drive the sensor apparatus 10 over the ground. The motor used to drive the movement means may be disposed within the driven member or within the wheel connecting member 88 and connected to the one or more driven members configured to drive the sensor apparatus 10 over the ground.

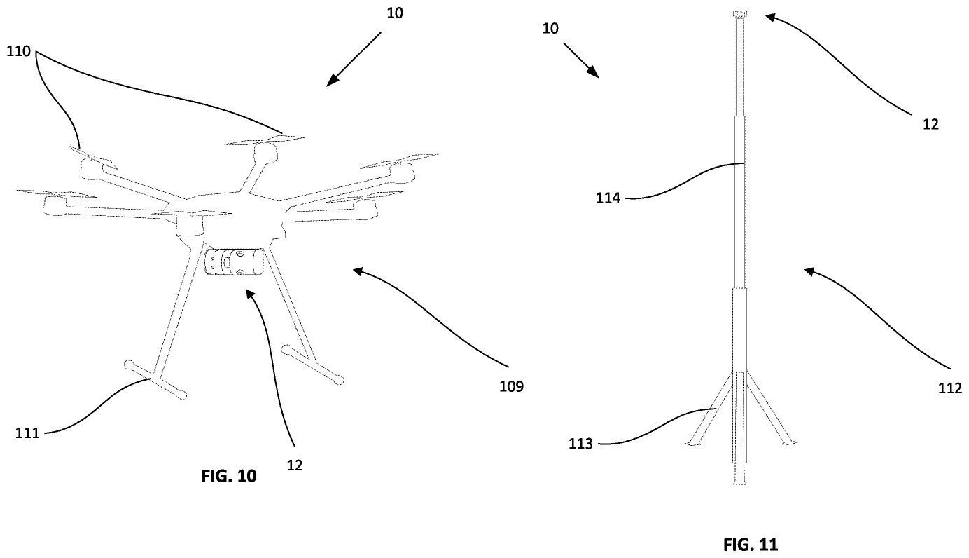

FIG. 10 shows a drone 109 to which the sensor unit 12 is mounted. The sensor unit 12 of this example may be the sensor unit 12 described with reference to any of FIGS. 1 to 8C. In this example, the sensor unit 12 may be attached to the drone by a support structure. This example drone 109 comprises one or more vertical lift generators, specifically, propellers 110, for generating vertical lift. The propellers 110 generate vertical lift and so the drone 109 is able to maintain a consistent position, i.e. the drone 109 can hover. The drone 109 also comprises a counter-balance 111 to improve stability of the drone 109 in flight, particularly while the sensor unit 12 is in operation. The drone 109 can be autonomously operated or remotely operated by an operator, and can be used to move the sensor unit 12 over an external or internal part of a building that might otherwise only be accessible by scaffold or ladder. The sensor unit 12 may be the same sensor unit 12 as the examples of FIGS. 1 to 7, and in this example the sensor unit 12 may be rotatably mounted to the drone 109. Alternatively, the sensor unit 12 may be the same sensor unit 12 as the examples of FIGS. 8A to 8C, and the sensor unit 12 may be fixedly mounted to the drone 109. In this example, a scanning motion can be provided by moving the drone 109 relative to the scanned object during flight.

FIG. 11 shows a support structure 112 that comprises a tripod 113 for positioning on a surface, such as a ground surface, and an extendible pole 114 to which the sensor unit 12 is mounted. In this example, the sensor unit 12 may be any of the sensor units 12 described with reference to FIGS. 1 to 8c. The extendible pole 114 is telescopic and can be extended to support the sensor unit 12 at heights for scanning higher storeys of buildings, for example a second storey or higher. Thus, use of scaffolding and ladders can be avoided, saving considerable cost. The support structure 112 is portable and can be moved between different buildings or different parts of a building for different scans.

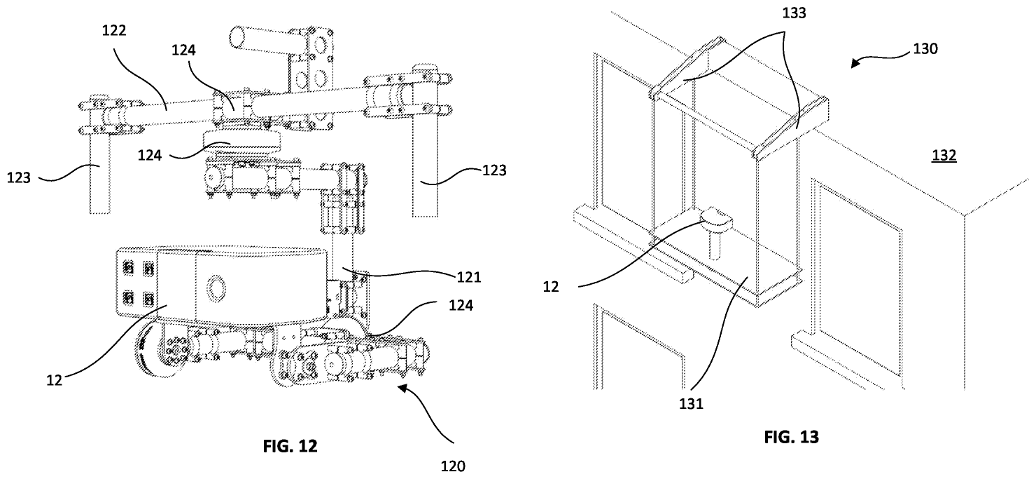

FIG. 12 shows a support structure 120 for the sensor unit 12 that comprises a gimbal 121. The gimbal 121 comprises a frame 122 and one or more handles 123 for a user to support and/or move the gimbal 121. The frame 122 includes one or more rotational or otherwise articulated joints 124 between the handle and the sensor unit that allow the gimbal and sensor unit to be moved while the sensor unit 12 maintains a stable position. The gimbal 121 is preferably designed to balance the weight of the sensor unit 12 such that sudden or erratic movements of the user and the handles 123 are not transferred to the sensor unit 12, providing a more stable platform for capturing sensor data. The gimbal 121 may include counterweights to improve the balance. Preferably, the sensor unit 12 of this example is the sensor unit 12 of FIGS. 8A to 8C, having the sensors 20, 16, 24 oriented in the same direction and a steady state LiDAR rangefinder 16. However, the sensor unit 12 may alternatively be the sensor unit 12 of FIGS. 1 to 7, which is rotated to capture scan data.

FIG. 13 shows a further example support structure 130 for the sensor unit 12. In this example, the support structure 130 comprises a platform 131 that is suspended from a roof 132 via support arms 133. The sensor unit 12 is mounted to the platform 131. As illustrated, the platform 131 may be suspended from a roof 132 of a building, but might otherwise be suspended from a ceiling or other raised part of a building. The portable scanning apparatus of this example can thereby be moved relative to the building by raising and lowering the platform 131 to obtain scan data. Preferably, the sensor unit 12 of this example is the sensor unit 12 of FIGS. 8A to 8C, having the sensors 20, 16, 24 oriented in the same direction and a steady state LiDAR rangefinder 16. However, the sensor unit 12 may alternatively be the sensor unit 12 of FIGS. 1 to 7, which is rotated to capture scan data. In this example, movement of the platform 131 can provide the scanning motion for the sensor unit 12.

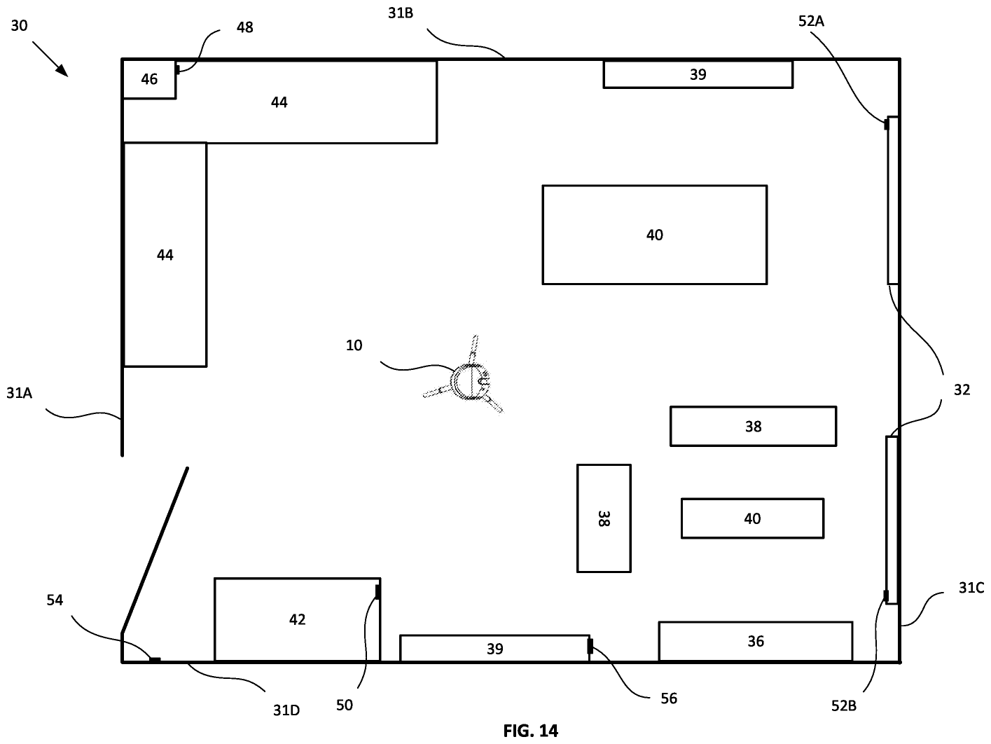

An exemplary deployment of the sensor apparatus 10 is shown in FIG. 14. In the illustrated example, the sensor apparatus 10 of any of FIGS. 1 to 13, but preferably those examples that include a tripod or similar support structure (i.e. FIGS. 1 to 8C, 9, 11) is situated in a room 30 having walls 31A, 31B, 31C, 31D, windows 32, appliances 36, a radiator 39, chairs or sofas 38, tables 40, cupboards 42, work surfaces 44, a boiler 46. The user positions the sensor apparatus 10 within the room 30, for example near a centre of the room, activates the sensor apparatus 10 so that each sensor captures data indicative of the environment of the room, moves through the scanning motion, and combines the data from each of the sensors into a combined dataset. The combined dataset can then be stored in a database and can be associated with the building. When the sensor apparatus 10 scans the room 30, the sensor apparatus 10 will capture data corresponding to the sensors on board the sensor unit 12. In the illustrated example, the sensor unit 12 captures thermal data, depth data and colour data.

The combined data set is preferably in a format that is compatible with existing building information management databases. For example, the combined data set may comprise database fields that are consistent with existing building information management databases, so that data in these fields can be directly copied or transferred into the existing building information management database. The combined data set may comprise further fields, not present in the building information management databases, that contain further information that is not compatible with the building information management databases. For example, the combined data set may comprise a plurality of text fields for containing information from the scan data, and a plurality of further fields containing further scan information, such as 3D model data. One of the fields of the combined data set may comprise a link to the further scan information hosted on a remote server, for example a cloud server. In this way, existing building information management databases can be used to store the scan data, and where compatibility is not possible, for example for 3D model data, the existing building information management databases can be supplemented by the further scan information stored on the remote server.

One or more of the sensors may also be used to detect an identifier in the room 30. The identifier may be used to tag an object or location in the room 30. The identifier may be affixed to an object semi-permanently or may be temporarily inserted into the room 30 by the user only for the duration of the sensing by the portable sensor apparatus 10. The identifier may be used by the user as a placeholder for subsequent additional data input into the combined dataset. The additional data may be data not captured by the sensors. In one example, the identifiers may be a visual identifier and the cameras 24 may be used to detect the visual identifiers. One example of a visual identifier may include a barcode, such as a QR® code.

In some cases, the identifier may indicate that an object should be kept in the combined dataset. In some cases, the identifier may indicate that an object should be ignored in the combined dataset. For example, one or more identifiers may be applied to any of electrical appliances 36, tables 40, cupboards 42 or work surfaces 44 in the illustrated room 30. Where these objects are not indicative of the environmental status of the room 30, these can be subsequently ignored in the combined dataset. In one example, an identifier 56 may be attached to a radiator 39 to indicate the radiator 39 should be retained in the combined dataset. This would allow for additional information about the radiator 39 to be included in the combined dataset. A different identifier 48 may be attached to a boiler 46. For example, additional information regarding the status of the boiler 46 can be accurately recorded as part of the combined dataset captured by the sensor unit 12. Further identifiers 52A, 52B may be attached to one or more windows 32. An identifier may be attached to electrical sockets (not shown) within the room 30. One or more identifiers may be attached to one or more pipes (not shown) within the room 30 or on a surface indicating the presence of a pipe behind one or more of the walls 31. An identifier 54 may be attached to a further sensor (not shown) within the room 30. This allows the combined dataset to include data not otherwise provided by the sensors within the sensor unit 12 itself.

The combined dataset may include data manually input by the user, data recorded by the further sensor, or data captured by other data sources.

For example, an operator may augment the data by adding annotations, removing data, and/or replacing information in the data set. For example, the operator may select at least some of the data to be deleted, for example the operator may select personal or confidential information captured in the scan data for deletion. Alternatively or additionally, the operator may replace at least some of the data with library information retrieved from a database. For example, data relating to an appliance, such as a refrigerator, may be isolated from other features of the building environment and replaced with library data relating to the refrigerator. The library data may include further information on the appliance, such as manufacturer details, maintenance history, and warranty information. Additionally or alternatively, the library data may comprise 3D model data for the appliance, which can replace the scan data to augment the scan data. In another example, the operator may remove all of the data associated with a feature, so that the feature is absent from the building model. In this example, walls behind the removed feature, such as a painting, may be extrapolated to fill the space left by removing the data. Data generated by extrapolating the wall may replace the removed data.

In one example the further sensor is a damp sensor (not shown). The damp sensor may be portable and be introduced into the room 30 by the user or be fixed within the room 30. In this example, the damp sensor can be used to indicate the presence of damp or mould at a specific location in the room 30, for example, on a particular wall 31D.

The additional data may be input during data capture or after data capture. The additional data may be input on-site or offline. Examples of additional data may include manufacturer details of the object tagged or in proximity to the tag, dates of installation or maintenance of the object tagged or in proximity to the tag, details of associated componentry or consumables, etc. Importantly, the additional data is localised in the scanned environment as its location is recorded by the sensor unit 12 when scanning the room 30. By integrating the additional data in the combined dataset of the room 30 and associating the dataset with a particular building, a more complete dataset indicative of the structural status of the building can be obtained. This can in turn be used to significantly reduce the inefficiencies with regard to building maintenance.

FIGS. 15A and 15B are illustrations of a further sensor device 100 for the portable sensor apparatus. The further sensor device 100 is for use with the sensor apparatus 10 disclosed hereinbefore. In some examples, the further sensor device 100 can be another component of the sensor apparatus 10 provided separate to the sensor apparatus 10. FIG. 15A illustrates a front view of the further sensor device 100. The further sensor device 100 is for attachment to a wall 31 of a room using attachment means (not shown), for example one or more suction cups. FIG. 15B illustrates a side view of the further sensor device 100, schematically showing an operation of a damp sensor of the further sensor device 100, and a construction of the wall 31. The further sensor device 100 includes a front surface 102 and a rear surface 104 substantially opposite the front surface 102. The front surface 102 is to face outwardly from the wall 31 when the further sensor device 100 is mounted to the wall 31. The rear surface 104 is to face inwardly against the wall 31 when the further sensor device 100 is mounted to the wall 31. The further sensor device 100 comprises at least one sensor 106, in the form of a damp sensor 106. It will be understood that the damp sensor 106 can be of any suitable type. In this example, the damp sensor 106 is an electrical sensor and comprises two wall contacts each for contacting the wall 31 when the further sensor device 100 is mounted to the wall 31. Using a conductance measurement, the damp sensor 106 can determine a damp indicator indicative of a damp level associated with the wall 31 in a vicinity of the further sensor device 100. In this example, the front surface 102 is provided with a reflector 108, for example a lidar reflector 108 which is reflective to the laser radiation emitted by the laser rangefinder sensor 16 of the sensor unit 12 described hereinbefore. Thus, the location of the further sensor device 100 in the room can be determined based on the reflectance caused by the reflector 108 and detected by the rangefinder sensor 16 of the sensor unit 12.

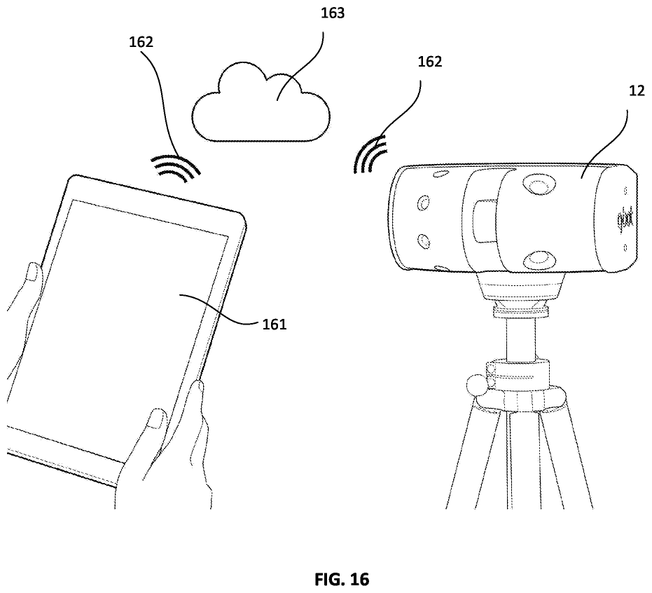

FIG. 16 shows a further device, in this example a tablet computer 161, in communication with the sensor unit 12. The tablet computer 161 receives output sensor data from the sensor unit 12. The tablet computer 161 may be a remote device, or it may be used by an operator of the sensor unit 12 at the same location as the sensor unit 12. The tablet computer 161 may communicate with the sensor unit 12 by a direct wireless communication, for example a Bluetooth or WiFi connection 162. Alternatively, the tablet computer 161 may communicate with the sensor unit 12 via a server 163. For example, the sensor unit 12 may be provided with a communications unit for uploading scan data to a server, and the tablet computer 161 can retrieve the scan data from the server. The tablet computer 161 preferably includes a screen and a graphical user interface, for example an Application, for viewing and preferably manipulating and/or augmenting the scan data as described above.

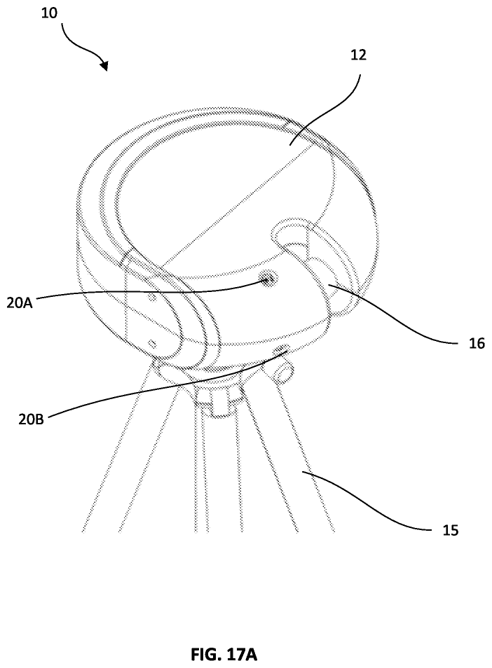

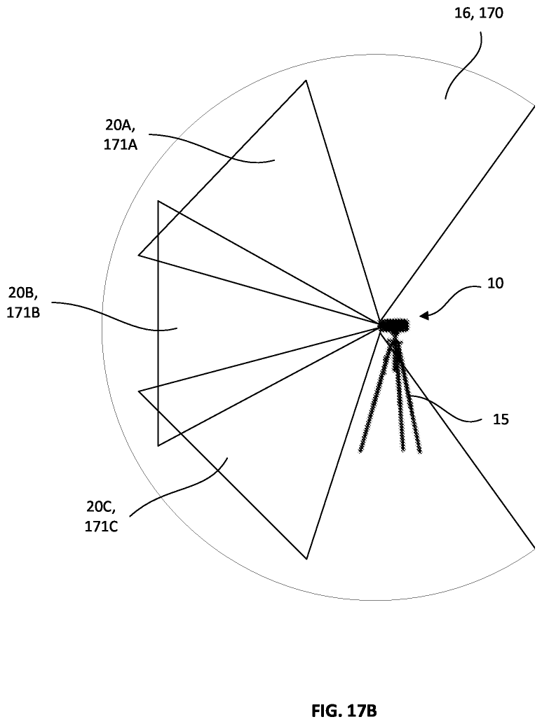

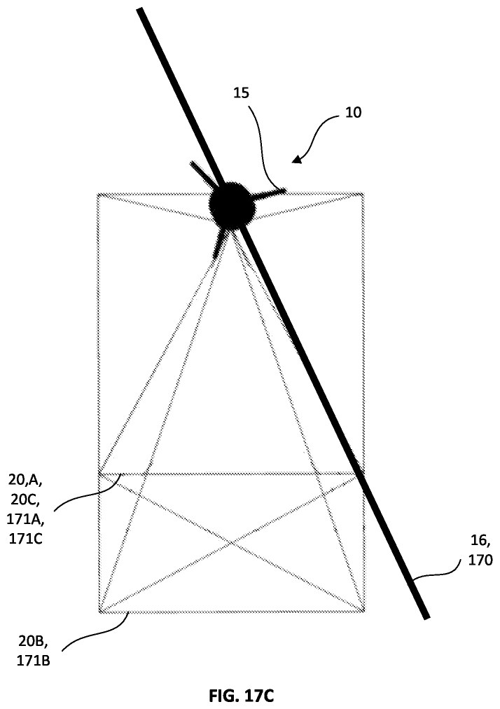

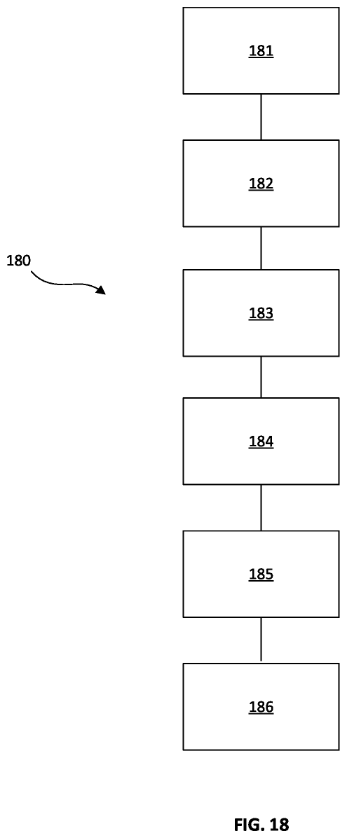

In a further example, illustrated in FIGS. 17A, 17B, and 17C, a portable sensor apparatus 10 for surveying a building. The portable sensor apparatus has a sensor unit 12 that comprises a rangefinder sensor 16 and plurality of outwardly directed thermal imaging sensors 20, in this example three thermal imaging sensors 20A, 20B, 20C (20C not visible in FIG. 17A). In this example, the sensor unit 12 may or may not include a camera as described in previous examples. The sensor unit 12 is moveable in a scanning motion such that the rangefinder sensor 16 and the thermal imaging sensors 20A, 20B, 20C capture sensor data associated with an environment of the portable sensor apparatus 10. In particular, the rangefinder sensor 16 captures range data associated with surfaces within the environment of the sensor apparatus 10, and the thermal imaging sensors 20A, 20B, 20C capture thermal data for surfaces within the environment of the sensor apparatus 10. The sensor unit 12 is moveable in a scanning motion, for example by rotation of the sensor apparatus 10.

In the example of FIGS. 17A, 17B and 17C, the sensor unit 12 is rotatable about the tripod 15, in the same way as described with reference to the examples of FIGS. 1 to 7. The tripod 15 or the sensor unit 12 may include a motor for motorised movement of the sensor unit 12 about the tripod 15.

As illustrated in FIGS. 17B and 17C, the rangefinder sensor 16 has a field of view 170. In the illustrated example, when viewed laterally (from the side) as shown in FIG. 17B, the field of view 170 of the rangefinder sensor 16 projects into the environment of the sensor apparatus 10 and has an angle defining the outer limits of the field of view 170. In the illustrated example, the field of view 170 has an angle of approximately 270 degrees, so the field of view 170 of the rangefinder sensor 16 encompasses the areas of the environment of the portable sensor apparatus 10 above and below the portable sensor apparatus 10. However, in other examples, the field of view 170 of the rangefinder sensor 16 may be 180 degrees or less. As illustrated in FIG. 17C, the field of view 170 of the rangefinder sensor 16 is planar when viewed from above or below the portable sensor apparatus 10. In this way, when the scanning unit 12 is moved through a scanning motion, for example by rotation about the tripod 15, the field of view 170 of the rangefinder sensor 16 passes over the environment of the portable sensor apparatus 10 to detect range information relating to surfaces of the environment of the portable sensor apparatus 10.

As also illustrated in FIGS. 17B and 17C, each of the thermal imaging sensors 20A, 20B, 20C also has a field of view, 171A, 171B, 171C, respectively. The fields of view 171 of each thermal imaging sensor 20a, 20B, 20C projects from the thermal imaging sensor 20A, 20B, 20C into the environment of the portable sensor apparatus 10 and each has an angle defining the outer limits of the field of view 171. As illustrated, the limits of the fields of view 171 of the thermal imaging sensors 20A, 20B, 20C diverge from the sensor unit 12 in the lateral plane (as viewed from above in FIG. 17C) and in the vertical plane (as viewed from the side in FIG. 17B).

As illustrated, the field of view 171 of each thermal imaging sensor 20A, 20B, 20C overlaps a field of view 171 of at least one other thermal imaging sensor 20A, 20B, 20C in overlapping regions 172. The thermal imaging sensors 20A, 20B, 20C thereby have a combined field of view, provided by aggregating the fields of view 171 of all of the thermal imaging sensors 20A, 20B, 20C, defined by the outer limits of each field of view 171.

Viewed from above or below, as shown in FIG. 17C, the fields of view 171 of the rangefinder sensor 16 and the thermal imaging sensors 20A, 20B, 20C may also overlap. In the illustrated example the plane of the field of view 170 of the rangefinder sensor 16 is angularly offset relative to the middle of the fields of view 171 of each of the thermal imaging sensors 20A, 20B, 20C, but there is still some overlap. When the sensor unit 12 is moved through a scanning motion, for example by rotation about the tripod 15, the same surfaces of the environment of the portable sensor apparatus 10 will be detected by the rangefinder sensor 16 and at least one of the thermal imaging sensors 20A, 20B, 20C because of the arrangement of overlapping fields of view 170, 171.

In an alternative example more similar to the example of FIGS. 10 and 11, the rangefinder sensor 16 and the thermal imaging sensors 20A, 20B, 20C may be arranged parallel to each other in the portable sensor apparatus 10, in which case the angular offset shown in FIG. 17C would not be present. Nevertheless, on movement of the sensor unit 12 through a scanning motion the same surfaces of the environment of the portable sensor apparatus 10 are detected by the rangefinder sensor 16 and at least one of the thermal imaging sensors 20A, 20B, 20C.

As explained above, the field of view 171 of each of the thermal imaging sensors 20A, 20B, 20C also overlaps the field of view of the rangefinder sensor 16, at least during movement of the sensor unit 12 through the scanning motion. Therefore, the field of view 171 of each of the thermal imaging sensors 20A, 20B, 20C at least partially overlaps the field of view 170 of the rangefinder sensor 16, and the field of view 171 of each of the thermal imaging sensors 20A, 20B, 20C at least partially overlaps the field of view 171 of at least one other thermal imaging sensor 20A, 20B, 20C.

In this way, the thermal imaging sensors 20A, 20B, 20C capture thermal data from a common surface point in the environment of the sensor apparatus 10, and the common surface point is also detected by the rangefinder sensor 16. This arrangement is advantageous for calibration of the thermal imaging sensors 20A, 20B, 20C, as described further hereinafter.

Although in the example of FIGS. 17A to 17C the portable sensor apparatus 10 has three thermal imaging sensors 20A, 20B, 20C, it will be appreciated that the portable sensor apparatus 10 may alternatively have two, four, or more thermal imaging sensors 20 arranged with overlapping fields of view 171 in the same way as described above.

It will also be appreciated that the sensor unit 12 may further include at least one camera, for example an RGB camera, arranged to capture images of the environment of the portable sensor apparatus 10. The camera or cameras may be arranged to have a field of view or combined field of view that overlaps the fields of view of the rangefinder sensor 16 and the thermal imaging sensors 20A, 20B, 20C.

In this way, the sensor unit 12 is configured to capture scan data associated with the environment of the portable sensor apparatus 10, particular scan data corresponding to surfaces of the environment of the portable sensor apparatus 10—i.e. the range of the surfaces, the temperature of the surfaces, and optionally an appearance of the surfaces. This scan data can be used to construct a point cloud model that is representative of the environment of the portable sensor apparatus 10. Such a point cloud model would comprise a plurality of points, each representative of a surface point, and each point having range data, thermal data, and optionally image data.

FIG. 18 schematically illustrates a method 180 of calibrating a sensor unit 12 that has a rangefinder sensor 16 and a plurality of thermal imaging sensors 20. In particular, the method 180 is for calibrating the thermal imaging sensors 20A, 20B, 20C. The method of FIG. 18 is described with reference to the portable sensor apparatus 10 described with reference to FIGS. 17A to 17C, but could be applied to any of difference example portable sensor apparatuses 10 described herein.

The thermal imaging sensors 20A, 20B, 20C are sensitive to surface temperatures that are detected in the environment of the portable sensor apparatus 10, and preferably detect temperature to an accuracy of at least 1/10 of a degree Celsius. When detecting surface temperatures using multiple thermal imaging sensors, as described with reference to the embodiments of the portable sensor apparatus, it is advantageous for the thermal imaging sensors to be calibrated to each other so that temperature variations across the surfaces are detected. It is advantageous to be able to detect temperature variations across a surface because temperature variations are indicative of the presence and effectiveness of thermal insulation, or the thermal performance of a scanned object. Moreover, thermal imaging sensors will have a drift or inconsistency that varies during operation of the portable sensor apparatus, meaning that it is advantageous to calibrate them in a constant process during use, based on the scan data, rather than when the portable sensor apparatus is manufactured.

As illustrated in FIG. 18, the method 180 comprises an initial step 181 of collecting or receiving data, particularly range and thermal data. In some examples data is collected by the sensor unit 12, in particular the rangefinder sensor 16 and the plurality of thermal imaging sensors 20A, 20B, 20C. In other examples, where the method 180 is performed after data collection, the initial step 181 may be a step of receiving data generated the rangefinder sensor 16 and the thermal imaging sensors 20. Data may be received directly from the sensor unit 12, for example from the wireless transceiver, or may be received from a further device, for example a server.

The data may be collected by performing a calibration scan using the portable sensor apparatus 10 described with reference to FIGS. 17A to 17C, or it may data captured during a normal scan of the environment surrounding the portable sensor apparatus 10. For example, a calibration scan may be performed to calibrate the sensors prior to performing a normal scan, or the data may be calibrated after or during a normal scan.

The method further includes a step 182 of combining the scan data from the rangefinder sensor 16 and the plurality of thermal imaging sensors 20 into a combined data set. In this step 182, the combined data set comprises a point cloud of the environment of the portable sensor apparatus 10, where each point of the point cloud is representative of a surface point and having an associated value from the rangefinder scan data (i.e. a distance from the scanning unit 12 to the surface point) and at least one thermal data value from at least one of the thermal imaging sensors 20A, 20B, 20C.

In some examples, the method 180 is performed by a processor of the portable sensor apparatus 10, for example a controller of the sensor unit 12. In other examples the method 180 is performed on a further device, for example the tablet computer 161 illustrated in FIG. 16. Step 182 of generating a combined data set may be performed by the scanning unit 12 or the remote device.

From the combined data set generated in step 182, the method 180 performs a step 183 of identifying surface points with more than one thermal data value. That is, step 183 identifies surface points in the combined data set where more than one thermal imaging sensor has provided a thermal data value. Such surface points are referred to as a ‘common surface point’. Common surface points therefore have range data from the rangefinder sensor 16 and at least two thermal data values from at least two of the thermal imaging sensors 20.

Step 182 may comprise identifying one common surface point, or a plurality of common surface points in the combined data set. As described further below, preferably the method step 182 comprises identifying all common surface points in the combined data set.

The method 180 further includes a step 184 of calculating a difference between the at least two thermal data values associated with the or each common surface point. The difference is indicative of a difference in thermal data values between two thermal imaging sensors 20 that have detected the common surface point. The difference is calculated by subtracting one thermal data value from the other. A difference can be calculated for each common surface point of the combined data set.

Next, the method 180 includes a step 185 of determining a calibration factor. The calibration factor is based on the difference calculated in step 184. The calibration factor may be based on only one difference (i.e. only one common surface point), or can be based on a plurality of differences (i.e. a plurality of common surface points). The calibration factor can be applied to the thermal data values obtained by at least one of the thermal imaging sensors 20.

The calibration factor determined in step 185 is typically a positive or negative value that is applied to at least one of the thermal imaging sensors 20 such that both thermal imaging sensors obtain the same thermal data values for the common surface point. For example, if a first thermal imaging sensor 20A has detected a thermal reading of 27.5 degrees Celsius for a common surface point, and a second thermal imaging sensor 20B has detected a thermal reading of 27.9 degrees Celsius for the same common surface point, the difference is 0.4 degrees Celsius. In this case, a calibration factor of +0.4 degrees Celsius may be applied to the scan data of the first thermal imaging sensor 20A, or a calibration factor of −0.4 degrees Celsius may be applied to the scan data of the second thermal imaging sensor 20B, or a calibration factor of +0.2 degrees Celsius may be applied to the scan data of the first thermal imaging sensor 20A and −0.2 degrees Celsius may be applied to the scan data of the second thermal imaging sensor 20B.

In step 186 the calibration factor is then applied to the thermal data values detected by the appropriate thermal imaging sensor 20, such that the thermal data values across the entire combined data set are calibrated. In some examples, the calibration factor is only applied to thermal data values detected by some of the thermal imaging sensors, leaving thermal data values detected by at least one thermal imaging sensor unchanged. For example, one thermal imaging sensor may be taken as a reference, and the thermal data values detected by the other thermal imaging sensor or sensors are corrected to match the reference thermal imaging sensor. In the example of FIGS. 17A to 17C, the middle thermal imaging sensor 20B may be taken as the reference, and the thermal data of the other thermal imaging sensors 20A, 20C may have the calibration factor applied to bring them into line with the reference thermal imaging sensor 20B. In this way, thermal data values across the combined field of view of the three thermal imaging sensors 20A, 20B, 20C are calibrated to each other.

In preferred examples, a single calibration factor may be determined based on all common surface points in the combined data set. In this example, described in detail below, a single calibration factor is calculated based on the differences of all common surface points, and the calibration factor is configured to minimise the aggregate difference across all of the common surface points. This calibration factor is then applied to all of the thermal data values across each of the multiple thermal imaging sensors. Any remaining difference between thermal data values of different thermal imaging sensors for common surface points can be rectified by taking one or the other, or by averaging the calibrated thermal data values for that common surface point.

A further example calibration method is described hereinafter.

In a first step analogous to step 181 of FIG. 18, scan data is received from a portable sensor apparatus 10 that includes a rangefinder sensor 16 and three thermal imaging sensors 20A, 20B, 20C, such as the portable sensor apparatus 10 of FIGS. 17A, 17B and 17C. The field of view 172A, 172B, 172C of each thermal imaging sensor 20A, 20B, 20C at least partially overlaps a field of view 172A, 172B, 172C of another thermal imaging sensor 20A, 20B, 20C and the field of view 170 of the rangefinder sensor 16, as shown in FIGS. 17B and 17C. In a step analogous to step 182 of FIG. 18, a combined data set is formed. The combined data comprises a point cloud of the environment of the portable sensor apparatus 10, each point of the point cloud having a range data value and at least one thermal data value. The combined data set includes common surface points that have been detected by more than one thermal imaging sensor 20A, 20B, 20C, thereby having more than one thermal data value. In this example, common data points would have been detected by thermal imaging sensor 20B and one of the other thermal imaging sensors 20A, 20C, as illustrated in FIG. 17B. In a step analogous to step 183 of FIG. 18, the combined data set is searched to identify the common surface points.

In a step analogous to step 184 of FIG. 18, for each common surface point, a difference measurement is calculated between the two thermal data values for that common surface point using the below formula:

eᵢₖⱼₘ=(lᵢ(uᵢₖ,vᵢₖ)+δᵢ)−(lⱼ(uⱼₘ,vⱼₘ)+δⱼ)

where (uᵢₖ, vᵢₖ) and (uⱼₘ, vⱼₘ) are the thermal data values from the two thermal imaging sensors, and where δᵢ and δⱼ are calibration factors applied to the thermal data values. In some cases, there will be a pre-existing calibration factor, otherwise the calibration factors are zero.

The above difference measurement is calculated for a plurality, or preferably all of, the common surface points in the combined data set.

From the calculated differences, an error vector is defined as follows:

e(δ)=Σeᵢₖⱼₘ(δᵢ,δⱼ)

If the two thermal imaging sensors are perfectly calibrated to each other (calibration factors=zero and differences are all zero), or if the current calibration factors result in perfect calibration (differences are zero), then the error vector would contain only zeros. Otherwise, in a step analogous to step 185 of FIG. 18, if (further) calibration is required, then the values of the calibration factors δᵢ and δⱼ are determined in order to minimise e. This is modelled as a matrix form least squares problem, as defined below:

e(δ)=Cδ−m

where C is a correspondence matrix in which each row consists of all zeros apart from the columns which are associated with the common surface points of each individual error measurement, which have a corresponding +1 and −1, e.g.:

Cᵢⱼₖₘ=[0,0, . . . ,1,0,0,0,−1,0, . . . ,0,0]

and where m is a vector of measurements lᵢ (uᵢₖ, vᵢₖ)−lⱼ (uⱼₘ, vⱼₘ), which are the differences between thermal data values.

Then, a random column of C and the corresponding row of δ is removed, allowing it to be inverted into a least squares problem, as below:

δ=(C^{T}C)⁻¹C^{T}m

The value of the calibration factor, δ, can then be determined to minimise e.

The determined calibration factor, δ, is then added to the thermal data values for each point of the point cloud, which provides overall thermal calibration for the 3D point cloud. As mentioned above, any remaining inconsistency between thermal data values of different thermal imaging sensors for common surface points can be rectified by taking one or the other, or by averaging the calibrated thermal data values for that common surface point.

The method of calibration described above is a closed form solution that does use numerical optimisation techniques, meaning that the method is computationally efficient and can work effectively fora large number of images. This is important as the scan data for a normal size room (e.g. a living room of a house) might include upwards of 300 thermal images, and the method can efficiently calibrate these images to each other in a single closed form matrix operation, as per the method described above.

In summary, there is provided a portable sensor apparatus 10 for surveying within a room 30 of a building. The sensor apparatus 10 comprises: a rotatable sensor unit 12 for temporary insertion into a room 30, the rotatable sensor unit 12 for rotation about a substantially vertical axis of rotation 62, and comprising a plurality of outwardly directed sensors 16, 20, 24 mounted for rotation with the rotatable sensor unit 12 and to capture sensor data associated with an environment of the sensor apparatus 10. The plurality of sensors 16, 20, 24 comprises: a rangefinder sensor 16; one or more thermal imaging sensors 20A, 20B, 20C, 20D; and one or more cameras 24A, 24B.

There is also provided a portable sensor apparatus for surveying a building. The sensor apparatus comprises a sensor unit for temporarily locating at the building. The sensor unit is moveable in a scanning motion and comprises a plurality of outwardly directed sensors arranged to capture sensor data associated with an environment of the sensor apparatus as the sensor unit is moved though the scanning motion. The plurality of sensors comprises a rangefinder sensor, a thermal imaging sensor, and a camera.

There is also provided a portable sensor apparatus for surveying a building. The sensor apparatus comprises a sensor unit for temporarily locating at the building, the sensor unit being moveable in a scanning motion. The sensor unit comprises a rangefinder sensor and a plurality of outwardly directed thermal imaging sensors arranged to capture sensor data associated with an environment of the sensor apparatus as the sensor unit is moved through the scanning motion. Each of the rangefinder sensor and the plurality of thermal imaging sensors has a field of view, and the field of view of each of the plurality of thermal imaging sensors at least partially overlaps the field of view of the rangefinder sensor. In addition, the field of view of each of the plurality of thermal imaging sensors at least partially overlaps the field of view of at least one of the other thermal imaging sensors of the plurality of thermal imaging sensors.

There is also provided a method of managing a record of a state of a building. The method comprises: positioning the portable sensor apparatus described above in a building; activating the sensor apparatus to capture sensor data from each of the plurality of sensors of the sensor apparatus, the sensor data being indicative of the environment of the sensor apparatus; combining the sensor data from each of the plurality of sensors of the sensor apparatus into a combined data set; and storing the combined data set in a database associated with the building as a record of a state of the building.

There is also provided a method of calibrating a portable sensor apparatus for surveying a building. In these examples, the sensor apparatus comprises a rangefinder sensor adapted to capture range data for surfaces in the environment of the sensor apparatus, and first and second thermal imaging sensors adapted to capture thermal data of the surfaces in the environment of the sensor apparatus. The first and second thermal imaging sensors have at least partially overlapping fields of view. The method of calibrating the portable sensor apparatus comprises: combining the range sensor data and the thermal sensor data into a combined data set representative of the surfaces of the environment of the sensor apparatus; identifying a surface point in the combined data set where both of the first thermal imaging sensor and the second thermal imaging sensor have captured thermal data; determining a difference between the thermal data of the first thermal imaging sensor at the identified surface point and the thermal data of the second imaging sensor at the identified surface point; determining a calibration factor configured to calibrate the first thermal imaging sensor and/or the second thermal imaging sensor; and applying the calibration factor to the thermal data of at least one of the first thermal imaging sensor and the second thermal imaging sensor.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. (canceled)

2. A portable sensor apparatus for surveying a building, the sensor apparatus comprising:
a sensor unit for temporarily locating at the building, the sensor unit being moveable in a scanning motion and comprising a rangefinder sensor and a plurality of outwardly directed thermal imaging sensors arranged to capture sensor data associated with an environment of the sensor apparatus as the sensor unit is moved through the scanning motion,
wherein each of the rangefinder sensor and the plurality of thermal imaging sensors has a field of view,
wherein the rangefinder and the thermal imaging sensors are arranged such that the field of view of each of the plurality of thermal imaging sensors at least partially overlaps the field of view of the rangefinder sensor at a given position of the sensor unit, and
wherein the field of view of each of the plurality of thermal imaging sensors at least partially overlaps the field of view of at least one of the other thermal imaging sensors of the plurality of thermal imaging sensors.

3. The portable sensor apparatus of claim 2, wherein a combined field of view of the plurality of thermal imaging sensors matches the field of view of the rangefinder sensor.

4. The portable sensor apparatus of claim 2, wherein the sensor unit is configured to rotate about an axis of rotation, and wherein the scanning motion comprises rotation of the sensor unit about the axis of rotation, the plurality of sensors being mounted for rotation with the sensor unit.

5. (canceled)

6. The portable sensor apparatus of claim 4, wherein a field of view of each of the rangefinder sensor, the one or more cameras and the one or more thermal imaging sensors is such that each of the rangefinder sensor, the camera and the thermal imaging sensor is configured to detect an object spaced by a predetermined minimum distance for each of the rangefinder sensor, the camera and the thermal imaging sensor from the sensor unit in either direction along the axis of rotation.

7. The portable sensor apparatus of claim 4, wherein a field of view of at least one of the plurality of sensors encompasses a first portion of the axis of rotation away from the sensor unit in a first direction and a second portion of the axis of rotation away from the sensor unit in a second direction opposite the first direction.

8. The portable sensor apparatus of claim 4, wherein the or each thermal imaging sensor and the camera are each arranged such that a principal axis of each of the or each thermal imaging sensor and the camera intersects with the axis of rotation of the sensor unit.

9. The portable sensor apparatus of claim 4, wherein the sensor unit comprises a first camera having a first camera principal axis and a second camera having a second camera principal axis, and wherein the first camera and the second camera are each arranged such that the first camera principal axis and the second camera principal axis substantially intersect with a first circle in a plane transverse to the axis of rotation and centred on the axis of rotation.

10. The portable sensor apparatus of claim 4, wherein the sensor unit comprises a plurality of thermal imaging sensors each having a thermal imaging sensor principal axis, and wherein each of the thermal imaging sensors are arranged such that the thermal imaging sensor principal axes intersect with a second circle in a plane transverse to the axis of rotation and centred on the axis of rotation.

11. The portable sensor apparatus of claim 4, further comprising a controller to control the plurality of sensors to capture the sensor data during rotation of the sensor unit.

12. The portable sensor apparatus of claim 11, wherein the controller is configured to control the sensor unit to rotate such that the plurality of sensors are arranged to capture the sensor data associated with 360 degrees of the environment of the sensor apparatus.

13. (canceled)

14. The portable sensor apparatus of claim 4, wherein the plurality of sensors are angularly spaced over less than 90 degrees about the axis of rotation on the sensor unit.

15. The portable sensor apparatus of claim 2, wherein the sensor unit comprises a camera, and wherein the rangefinder sensor and the camera are arranged such that a field of view of the rangefinder is configured to overlap, at least partially, with a field of view of the camera.

16. The portable sensor apparatus of claim 2, wherein the sensor unit comprises a plurality of thermal imaging sensors, and wherein each of the plurality of thermal imaging sensors has a field of view, and wherein the field of view of each of the plurality of thermal imaging sensors at least partially overlaps the field of view of at least one of the other thermal imaging sensors of the plurality of thermal imaging sensors.

17. The portable sensor apparatus of claim 2, further comprising a support structure, wherein the sensor unit is spaced from the ground surface by the support structure.

18. The portable sensor apparatus of claim 17, wherein the sensor unit is mounted to the support structure for rotation relative to the support structure.

19. The portable sensor apparatus of claim 18, wherein the sensor unit is mounted for motorised rotation relative to the support structure.

20-24. (canceled)

25. The portable sensor apparatus of claim 2, further comprising one or more further sensors comprising one or more of a temperature sensor, a humidity sensor, a carbon dioxide sensor, and/or an air particulate sensor.

26. The portable sensor apparatus of claim 25, wherein at least one of the further sensors is separate to the sensor unit.

27. The portable sensor apparatus of claim 25, wherein the further sensor device comprises a locating tag, configured to be detectable by at least one of the sensors of the sensor unit, whereby to locate the further sensor device in the environment sensed by the sensors of the sensor unit.

28. The portable sensor apparatus of claim 25, further comprising a controller and a wireless transceiver configured to be in wireless communication with a further device, and wherein the controller is configured to output sensor data from the plurality of sensors to the further device via the wireless transceiver.

29-39. (canceled)
